(19) United States
(12) Patent Application Publication
(10) Pub. No.: US 2026/0134489 A1
(43) Pub. Date: May 14, 2026

(54) High Asset Utilization with Distributed Queuing Data Center and Co-located Asset Integration

(71) Applicant: Michael Gurin, Glenview, IL (US)

(72) Inventor: Michael Gurin, Glenview, IL (US)

(21) Appl. No.: 19/437,908

(22) Filed: Dec. 31, 2025

Related U.S. Application Data
(63) Continuation-in-part of application No. 19/231,523, filed on Jun. 8, 2025.
Application No. 19/231,523 is a continuation-in-part of application No. 18/534,402, filed on Dec. 8, 2023.

(51) Int. Cl. G06Q 50/06; G06Q 30/0283

(52) U.S. Cl. CPC G06Q 50/06; G06Q 30/0283

(57) ABSTRACT

An asset queuing system, whether it be for a data center system or power generation system or otherwise shared resource of pooled assets, including both a dynamic pricing system and billing system, to dynamically reallocate tasks inclusive of computational tasks being performed on computational asset or electricity production on a power generation system with queuing and location placement amongst proximity locations based at least in part on valorization of operational byproducts. The system controls queuing of assets and tasks specifically accounting for variations of time of day or seasonal by combining feedforward and feedback loop control system as a function of revenue derived by the operational byproducts in addition to dynamic placement of primary asset task and assets into an extended network of multiple proximity locations.

### CROSS-REFERENCE TO RELATED APPLICATIONS

This patent application claims the benefit of U.S. Ser. No. 19/264,852 filed on Jul. 10, 2025 and titled “High Efficiency and Asset Utilization Data Center by Thermally Integrated Co-located Processes”; and U.S. Ser. No. 19/231,523 filed on Jun. 8, 2025 and titled “High Utilization Reconfigurable Asset Swapping Logistics System” hereby incorporated by reference in its entirety.

### BACKGROUND

The rapid rise of machine learning has created a massive rise of data centers placing significant aggregate power consumption demands in addition to water resources often placing additional strain on water treatment facilities, most notably within the host community. Both the placement of the data centers and the subsequent operations of the data centers is almost exclusively based on operator profit maximization (typically on an individual basis such as data center at a first data center location within the host community, and less frequently on an aggregate profit maximization for a first data center location and an at least one second data center location for a common owner or beneficiary. This operational strategy is creating an increasing trend of not in my backyard attitudes towards data centers. Additionally, as often the case in the real estate business and even renewable energy power generation, the potential for significant overbuilding of data centers having computational asset with computational capacity exists driving a reduced utilization factor for computational asset within individual data centers and even more so for the aggregate of data centers with their aggregate of computational asset and their then aggregate of computational capacity for the aggregate of owners or beneficiaries.

The data centers in most instances are interconnected via the Internet analogous to power generation systems interconnected via the electric grid and other grid utility providers. Both the Internet and the electric grid have active and dynamic switching (i.e., approximately instantaneous routing) enabling rapid variability of computational asset and energy production devices serving their respective networks with computational capacity and energy production capacity. The respective computational capacity and energy production capacity are both capable of approximately instantaneous decisions due to neither having physical logistics requirements.

Within the power generation market, due to grid utility providers via grid interconnections within the electric grid, dynamic pricing systems exist (e.g., ERCOT, PJM, etc.) creating an instantaneous real-time pricing as well as structured prioritization response system for example differentiating between baseload and intermittent capacity power generation system. Balancing authorities oversee the integration and real-time balancing of these generator types, adjusting dispatchable plants in response to variable output from intermittent resources and changing demand instantaneously and continuously. This hierarchical structure ensures reliability and least-cost supply into the electric grid even as renewable penetration rises, but it adds operational complexity for grid operators. However, it must be recognized that the grid utility providers benefit the most by realizing a supply cost minimization framework (i.e., low-cost bidder preference) at the direct cost of individual asset margins to power generation system owners and also driving down utilization factors for both the aggregate of power generation systems and most often to individual power generation systems. Within the electric grid, particularly for non-baseload power generation system assets (e.g., solar and wind), this drives periods of market pricing with a negative supply pricing and/or curtailment periods uniquely to the electric grid due to instantaneous voltage and frequency requirements. Relatively rapid switching of variable production rates and the potential for on/off switching of energy production devices enables dynamic pricing systems for grid utility providers.

Data centers interconnected via the Internet do not have the same instantaneous voltage and frequency requirements as the electric grid, yet both data centers and power generation systems have real-time perishable capacity. The ability of data centers to have faster variability of computational load, relative to power generation system variability, now presents the opportunity for a network (i.e., Internet) of computational asset to participate in a dynamic pricing system marketplace. The combination of data center perishable capacity (i.e., instantaneous oversupply) and faster variability of computational load presents the challenge of data centers operating at less than fully amortized break even. Data centers, like power generation systems having on-site energy storage devices with spare energy storage capacity (a.k.a.., on-site demand), can concurrently perform for the Internet demand and on-site demand. Both data centers and power generation systems produce at least one operational byproduct being waste heat (a.k.a., thermal energy having thermal energy quality).

Prior art includes the field of data center operations having high capital costs and high energy operating costs that lead to data center location placement impacted by direct aggregate power consumption and data communications having high-speed, low-latency connections. This is true for machine learning (a.k.a. AI) data centers whether of the learning or inference type. The recent explosive growth of AI data centers has led to an increase in data center scale with an increase in aggregate power consumption and aggregate thermal production, leading to shortages of power from grid utility providers driving on-site demand supplied via on-site microgrid power generation systems. The AI data center size as a standalone data center asset system leads to diminishing opportunities for co-location facility benefits for waste heat utilization. A massive size mismatch occurs between data center operational byproducts and co-location facility utilization or valorization of data center operational byproducts. The byproduct mismatch occurs for power generation systems that are grid utility providers.

Further prior art for data center operations with waste heat generated due to safe and long-term stable operations is too low quality preventing high value utilization. State of the art data centers leverage immersion cooling systems (or liquid cooling system as used interchangeably) to reduce cooling energy, though higher than air-cooling systems is also of too low quality beyond winter heating in directly adjoining facilities. Both liquid cooling system and immersion cooling system have advantage of higher thermal conductivity heat transfer fluid, as compared to air-cooling system, as well as superior thermal isolation of the data center from the host community thermal management systems. Piping for heat transfer fluids provides superior docking/undocking mechanisms compared to larger volume requirement of airflow within air-cooling system.

Another challenge for standalone data center operations is low utilization rates of computational asset (e.g., GPU, CPU, etc.), which exacerbates by non-data center deployment of large quantities of distributed computational asset that can perform similar, alternative, or identical computational task as computational asset in standalone data centers. Another challenge for standalone data centers is insufficient revenue generation to realize a return on investment of the massive capital investments, in part due to low utilization rates of computational assets performing primary asset tasks of computational tasks by computational assets. An additional challenge for data centers includes capital asset expenditures for air-cooling system and/or immersion cooling system due to variation of time of day or seasonal in which an ROI is realized. Inexpensive “free” cooling can be realized during winter operations in especially cold climates, and therefore no ROI is realized for any cooling assets during winter operations (and potentially during spring and fall operations). Free cooling eliminates opportunities for waste heat to be valorized. Yet another challenge for data centers includes water consumption when considering expense minimization at the first data center location.

A need exists for an asset queuing system to reduce perishable capacity by accounting for operational byproducts and not solely primary products of the Internet connected data centers and/or electric grid connected power generation systems. A need exists to valorize operational byproducts into a more integrated data centers and/or power generation systems with co-located facilities including biomass growing facilities and water treatment facilities, with variation of time of day or seasonal impact to avoid times with no ROI. Another need exists of heat pumps and mechanical vapor recompression systems to realize bi-directional incentives for data center with biomass growing facility and/or water treatment facility benefits. A further need exists for selecting biomass growing facilities and water treatment facilities that require lower temperatures than traditional facilities, such that data centers waste heat can be utilized year-round with high utilization factors for capital assets having designs for thermal integration scenarios. Yet another need exists for facilities that have concurrent heating and cooling requirements, whether one distinct facility has heating and cooling needs or whether the facility consists of distinct co-located or proximity location processes with thermally isolation to maintain independent process control yet gain energy efficiency through mechanical vapor recompression systems. Thus, heating needs can be met at a first location and cooling needs at a second location, with locations being on-site, co-located location, or proximity locations.

The need to maximize data center utilization at maximum computational capacity with maximum revenue is required to realize a ROI of data centers including infrastructure support equipment (e.g., cooling systems, water treatment facility, power generation system whether for primary power or backup power), thus minimizing perishable capacity. The challenge for computational asset within data centers is the concurrent increase in computational asset having graphic processing units “GPUs” suitable for machine learning as available in smartphones, autonomous vehicles, etc. to further flood market availability driving down operating margins. Thus, virtually all computational assets that are connected to the Internet has perishable capacity reducing the utilization factor of computational assets regardless of location. It is recognized that variable operating costs are dominated by energy aggregate power consumption further exacerbated by energy dense microprocessors (CPU or GPU) that place direct energy costs and indirect thermal management costs at the data center computational asset location. And it is recognized that power generation system variable operating costs are dominated by fuel expenses that places direct energy costs and indirect thermal management costs at the power generation system location. Yet the integration of power generation system with pyrolysis processes yielding high value carbon nanotubes or graphene enables expansion of locations in which power generation systems can be physically located.

### BRIEF SUMMARY

The data center, as well as power generation system, preferentially employs an asset queuing system to minimize perishable capacity by preferentially including a feedforward module that further preferentially includes operational byproducts. The data center, as well as power generation system, preferentially employs an asset queuing system to minimize perishable capacity by preferentially serving both remote (respectively Internet and electric grid) demands in addition to on-site demand. The data center, as well as power generation system, preferentially employs an asset queuing system to minimize perishable capacity by preferentially serving both remote (respectively Internet and electric grid) demands in addition to on-site demand that is further routed to serve demands at proximity locations. The data center, as well as power generation system, preferentially employs an asset queuing system to increase revenue from operational byproducts including redeploying of at least 5 percent of computational asset, power generation system, and/or energy storage devices to serve demands at proximity locations. The data center, as well as power generation system, preferentially employs an asset queuing system to increase revenue from operational byproducts including redeploying of at least 5 percent of computational asset, power generation system, and/or energy storage devices to serve demands at proximity locations; and further including a dynamic pricing system to offset at least 5 percent of then incurred operating costs at proximity locations.

The data center, as well as power generation system, preferentially employs an asset queuing system to redeploy at least 5 percent of computational asset, power generation system, and/or energy storage devices to proximity locations; and further including a dynamic pricing system to ensure that benefits realized at the proximity locations exceeds by at least 5 percent of then incurred operating costs at proximity locations attributed to the redeployment of the at least 5 percent of computational asset, power generation system, and/or energy storage devices to proximity locations. The data center, as well as power generation system, preferentially employs an asset queuing system to redeploy at least 5 percent of computational task to computational asset at proximity locations; and further including a dynamic pricing system to ensure that benefits realized at the proximity locations exceeds by at least 5 percent of then incurred operating costs at proximity locations attributed to the redeployment of the at least 5 percent of computational task at the proximity locations. The data center, as well as power generation system, preferentially employs an asset queuing system to redeploy at least 5 percent of computational task to computational asset at proximity locations; and further including a dynamic pricing system to ensure that benefits realized at the proximity locations exceeds the combined operational byproducts benefit value plus the at least 5 percent of then incurred operating costs at proximity locations attributed to the redeployment of the at least 5 percent of computational task at the proximity locations.

This data center system preferentially employs immersion cooling and air-cooling systems to control the data center temperature. The system includes a first partial data center electronics and a second partial data center electronics, each with its own heat source. The first heat source is from an immersion cooling system, which is in direct thermal contact with the first partial data center electronics. The second heat source is from an air-cooling system, which is in indirect thermal contact with the second partial data center electronics.

The system also includes a mechanical vapor recompression system “MVR” system or heat pump system, which uses a compressor, expansion component, regenerative heat exchanger, and third heat rejection sink to enhance the cooling capacity of the air-cooling system. The first heat rejection sink has a temperature that is at least 10 degrees Celsius higher than the second heat rejection sink. The data center system incorporates a thermal energy recovery system, which involves a facility with a waste heat source providing a fourth heat source. This fourth heat source is in thermal communications with the regenerative heat exchanger upstream of the compressor. The system also involves a biomass growing facility, which utilizes a biomass growing facility relative humidity and a biomass growing temperature. The system further includes a water treatment facility that utilizes heat from the third heat rejection sink. The data center system also comprises a dual electrolyzer electrochemical system in thermal communications with the third heat rejection sink and a power generation system that produces electricity for the at least one of the first partial data center electronics or second partial data center electronics. In addition, the data center system includes a solar-facing side that consumes a solar energy source and a non-solar-facing side that radiates a thermal energy source. The system also involves a power generation system that produces a carbon dioxide exhaust source, which is stored within the non-solar-facing side.

The data center system also comprises a feedforward and feedback loop control system that controls the temperature of the data center. The system includes a first partial data center electronics and a second partial data center electronics, each with its own heat source. The system also includes a plurality of sensors that measure a plurality of parameters relating to the first partial data center electronics and the second partial data center electronics. The control system determines a feedforward temperature control contribution based on the disturbance temperature transfer estimates and a feedback temperature control contribution based on a measured temperature of the first partial data center electronics and the second partial data center electronics and a temperature setpoint. The system combines the feedforward temperature control contribution and the feedback temperature transfer contribution to determine a target temperature setpoint to be provided to the first partial data center electronics and the second partial data center electronics by the immersion cooling system and the air-cooling system. The control system controls the immersion cooling system and the air-cooling system to achieve the target temperature setpoint. The system also determines the required values of cooling by the immersion cooling system and the air-cooling system to achieve the target temperature setpoint, and the determination of a predicted deviation between an actual value and a required value of the cooling by the immersion cooling system and the air-cooling system is at least in part based on a future required value of the co-located process thermal transfer rate.

Overall, the data center system employs a combination of immersion cooling, air cooling, and thermal energy recovery systems to control the temperature of the data center. The system also incorporates a feedback and feedforward loop control system that controls the temperature of the data center. It is understood that references to data center can be interchanged with virtually any facility that has both concurrent heating and cooling requirements, whether one distinct facility has both heating and cooling needs or whether the facility consists of distinct co-located processes that are thermally isolated, such that independent control of each process is maintained though the combination of feedforward and feedback loop control systems with mechanical vapor recompression systems provides for superior energy efficiency in combination with a high energy efficiency and high utilization asset system.

The asset queuing system for power generation systems, including for data center asset systems, has an on-site energy storage capacity to deployable energy storage capacity ratio less than 1:1 and preferentially less than 1:2, a range of 1:1, 1:2, 1:3, 1:4, 1:5 through 1:20 (explicitly any continuous range from 1:1 to 1:20). The asset queuing system for power generation systems, including for data center asset systems, has an on-site energy storage capacity to deployable power generation system energy production capacity ratio less than 1:1 and preferentially less than 1:2, a range of 1:1, 1:2, 1:3, 1:4, 1:5 through 1:20 (explicitly any continuous range from 1:1 to 1:20). The preferred ratio is lower for corresponding lower periods of time having a lower probability threshold of electric grid disruptions. The preferred ratio is lower for corresponding lower periods of time having a lower logistics distance of deployable power generation systems or deployable thermal energy storage capacity at an at least one available proximity location.

The asset queuing system for cooling systems, including for data center asset systems, has an on-site thermal energy storage capacity to deployable thermal energy storage capacity ratio less than 1:1 and preferentially less than 1:2, a range of 1:1, 1:2, 1:3, 1:4, 1:5 through 1:20 (explicitly any continuous range from 1:1 to 1:20). The asset queuing system for thermal management systems has an on-site thermal energy storage capacity to deployable thermal energy storage capacity ratio or to deployable power generation system energy production capacity ratio less than 1:1 and preferentially less than 1:2, a range of 1:1, 1:2, 1:3, 1:4, 1:5 through 1:20 (explicitly any continuous range from 1:1 to 1:20).

This summary is provided merely to introduce certain concepts and not to limit and identification of any or all key or essential features of the claimed subject matter.

### TERMS AND DEFINITIONS

“Actuator” refers to a device or system that varies/controls a parameter including a docking position, a physical parameter set, and a compliant mechanism to physically move any component of the system, notably a critical component within the docking port, docking connector, docking position or required to perform an orientation change, energy density change, energy storage capacity, etc. of the deployable cargo.

“Adjustment solicitation ratio” refers to the ratio of adjustment solicitations sent to total adjustments made, used to measure the effectiveness of asset re-allocation and task re-allocation in the dynamic queuing system. “Aggregate power consumption” refers to total power consumption of all components within the data center system, notably the power consumption that directly powers the data center electronics and indirectly powers the cooling requirements to maintain long-term and efficient operations of the data center electronics. “Aggregate thermal production” refers to the total thermal energy generated by multiple sources whether it be multiple electric power generation system units or waste heat such as from data centers, typically measured in megawatts (MW.sub.thermal) or megawatt-hours (MWh.sub.thermal).

“Air-cooling system” refers to a cooling system that uses air as the medium for heat transfer, where a fluid (usually water or a water-based solution) is pumped through a heat exchanger to absorb heat from the data center electronics, which is then dissipated into the surrounding air through a radiator or other heat transfer device. “Air-moving device” refers to any device capable of creating a pressure differential resulting in the movement of airflow from a first location to a second location, commonly including mechanical devices such as fans, impellers, and compressed air, and less common including electrical devices such as ion generators. “Air-side heat exchanger” refers to equipment that transfers heat from a fluid flowing through the air (or gas) to another fluid flowing through a cooled medium, typically in a data center or industrial cooling system. “Airflow” refers to the movement of air within the data center system, specifically in the air-cooling system, which is a flow of air that is used to remove heat from the second partial data center electronics by natural convection. The co-location of secondary non-data center processes leverages the same airflow in many embodiments.

“Amortization adjustment rate” refers to the rate at which the cost of an asset is spread over its useful life, typically expressed as a percentage, used to adjust the value of an asset on the balance sheet. In this context, it refers to the rate used to adjust the value of an asset in an asset queuing system, considering the revenue generated by the operational byproducts of the asset.

“Asset queuing system” refers to a computer system that dynamically manages and schedules tasks, computational resources, or physical assets (such as power generation or cooling systems) to optimize resource utilization, efficiency, and revenue generation, often considering factors like time of day, seasonal demand, and byproduct valuation specifically enabling deployment of an asset from a first location to at least one proximity location.

“Autonomous” refers to operating independently without external control or human intervention. In the context of the data center asset system, “autonomous” refers to the system's ability to function and operate on its own. “Autonomous vehicle”, hereinafter also referred to as “AV”, is any movable device capable of operating without any onboard driver. The preferred embodiment of a vehicle is autonomous, but it is understood that the functionality of this invention is not dependent on the vehicle being autonomous (and therefore simply referred to as vehicle). The term portable host, vehicle and autonomous vehicle are used interchangeably for the implementation of this invention.

“Backup energy capacity shortfall” refers to insufficient energy capacity for any system or device that provides electricity to essential loads when the primary power source fails or is unavailable. Backup energy systems are designed to maintain the operation of critical equipment and infrastructure particularly during energy (a.k.a. power) outages, whether the disruption is brief or extended. “Baseload” refers to a level of power or resource utilization that is typically maintained at a constant level over a period of time, providing a steady and reliable supply. In the context of the provided text, baseload refers to the level of power production or computational task utilization that is maintained at a constant level, providing a steady and reliable supply, often in contrast to variable or intermittent resources. “Behind-the-meter” refers to capacity and assets that are owned and/or operated for the beneficiary to the end-user or customer, typically for their direct use, as opposed to assets that benefit third-parties physically located elsewhere. In the context of energy and resource management, “behind-the-meter” systems refer to on-site assets and systems that serve the needs of a specific facility or location, often for billing and management purposes.

“Biomass growing facility” refers to a facility or structure that houses equipment for growing plants or microorganisms producing biomass or foods, including at least a portion of the resulting biomass for transformation into fuel feedstock for power generation system. “Biomass growing temperature” refers to temperature within the physical space where biomass is being grown.

“Carbon dioxide exhaust source” refers to a carbon dioxide created by the fuel combustion in the power generation system, including biomass derived fuel feedstock.

“Channel diverter” refers to a component or mechanism that redirects or diverts air or heat transfer fluid from a first directional vector to a second directional vector. “Charging price” refers to a client price established for the loading of energy onto an energy storage device. “Circulation energy” refers to the energy consumed as a result of the movement of fluids, such as water or air, within an asset. This is typically pumping energy for fluids and fan energy for airflow.

“Co-location facility” refers to a facility that shares resources, utilities, or processes across multiple individual processes (including data center, biomass growing facility, water treatment facility, etc.) in close physical proximity and that are thermally integrated and preferably also airflow integrated.

“Compressor” refers to a mechanically driven device designed to increase the pressure and temperature of vapor—often steam though any as known in the art refrigerant, so that the vapor downstream of the compressor can be reused as a heating medium within the same process.

“Computational asset” refers to equipment or devices that perform computational tasks, such as servers, data storage devices, or other processing units, typically found in a data center or computing environment, that can be dynamically allocated and managed by the asset queuing system.

“Computational capacity” refers to the ability of a system, device, or asset to perform computational tasks, such as processing, calculation, or analysis, measured by its processing power, number of processing units, or ability to complete tasks within a given timeframe.

“Computational task” refers to a unit of work or operation performed on a computational asset, such as a processor or server, that can be executed or executed in a specific order, and can be dynamically allocated or reassigned as part of the asset queuing system.

“Consumption adjustment ratio” refers to a numerical value that accounts for a proportionate adjustment differentiating between standby periods in which the asset queuing system has explicitly requested an asset to become made available as solicited made available for queuing with asset confirming availability for pool utilization versus the asset becoming “made available” on an unsolicited basis as unsolicited made available.

“Control system” refers to a set of mechanisms and algorithms that monitor and adjust the external combustion system operating parameters in real-time to optimize the external combustor reaction, including the flow rates and temperatures of the fuel and air flows. The control system is understood to be capable of monitoring and/or adjusting processes upstream and/or downstream of the external combustor.

“Data center”, also interchangeably known as “data center”, “data centre” or “datacentre”, refers to a dedicated space, and/or modular system (often within a physical building) that houses computer systems and associated components, such as servers, storage systems, networking equipment, and telecommunications infrastructure. The data center can be a multi-tenant or virtual machine interface as known in the art. A virtual machine is a software construct designed to run computer programs like a real physical machine. As an example, a virtual machine may comprise various software components for running executable code written for a particular computing platform. Such executable code may include, among other things, operating system code, application programs, software drivers, and so on. For the purpose of this invention, it can be a broader definition of any solid-state device in which direct current electricity is utilized and at least 2 percent of the electricity creates heat that increases the operating temperature of the solid-state device).

“Data center asset system” refers to a physical or virtual infrastructure that houses and supports the operation of data center electronics, including equipment, systems, and components that store, process, and transmit data, and is designed to provide reliable and efficient operation of the electronics.

“Desiccant regenerator” refers to a component that absorbs or adsorbs moisture from the air and releases it when heated, used in cooling and dehumidification systems to remove humidity. In the context of the data center system, it is used to remove moisture from the air to enable subsequent evaporative cooling. In the context of the greenhouse, it is used to remove moisture from the air to optimize relative humidity for plant growth and to minimize mold growth within the greenhouse.

“Direct on-chip cooling” refers to the application of thermal management technologies directly on the surface of a computing device or chip, typically through the use of microchannel heat sinks, liquid cooling, or other specialized cooling systems, to reduce the temperature of the device and improve its performance and reliability.

“Dual electrolyzer electrochemical system” refers to an electrochemical device utilizing organic molecules, as known in the art, to reduce electricity input (i.e., lower than 20 kWh of electricity to produce hydrogen) in the production of at least hydrogen via the hydrogen evolution reaction “HER”.

“Duct” refers to a method of first containing a gaseous material, notably stored carbon dioxide exhaust source, from a first location to a second location typically as moved via pressure differential across an air-moving device.

“Dynamic addressing” refers to a physical address, whether it be defined in a traditional street method (e.g., 123 Street A, City, State, Country) or a precise GPS coordinate system that changes notably for a data center. The utilization of dynamic addressing specifically recognizes and optimizes the position of the data center to minimize the aggregate logistics cost for deployable assets serving a series of next locations amongst assigned or likely (as determined by the statistical probability projected database) location candidate sets. The dynamic addressing for a data center, a deployable asset, and a second location for reconfiguring a deployable device, based on real-time information and dynamic routing algorithms, optimizes the delivery schedule and minimizes the delays and cost for the aggregate of deployable assets, deployable cargos, etc.

“Dynamic pricing system” refers to pricing variations at the least as a function of time and typically further as a function of at least one of: a) variation of time of day or seasonal, b) prioritization response system, c) backup energy capacity shortfall, d) utilization factors for deployable assets, e) utilization factors for deployable cargos, etc. Further pricing variations include a function of service task, feedforward computational task vs. reverse logistics task, etc.

“Electric grid” refers to a network of interconnected electrical power stations that supply electrical power to a specific geographic area, with the ability to transmit power over long distances through transmission lines, specifically differentiated from behind-the-meter electric sources.

“Electronics” refers to in the context of data center systems, “electronics” refers to the electronic components, such as servers, storage systems, switches, and network equipment, that process and store data.

“Emissions profile” refers to a graphical representation of the concentrations of various species, such as gases or particles, emitted by the combustor as a function of multiple parameters impacting combustion including any active catalyst on-stream time, real-time flow rate or real-time temperature etc., particularly downstream of the combustor.

“Enclosure” refers to a containment system that surrounds and protects the critical components from environmental exposure.

“Energy demand profile” refers to a function of time representation of the amount of energy required by a system or device over a specific period of time (e.g., typically 30 minutes during peak demand periods as determined by the energy provider). In the context of the data center asset system, it refers to a predicted or actual energy demand graph that shows the energy consumption of the deployable devices or systems at different locations and under various configurations.

“Energy production capacity” refers to the available or rapidly dispatch-able within statistical probability projected database capacity to supply power to typically a stationary user (though can also be mobility user) for a specified duration or amount of time.

“Energy production device” refers to a component that generates energy, whether it be electricity (a.k.a. power) or thermal energy to enable the operation of a function of a deployable cargo or deployable asset.

“Energy storage capacity” refers to he available or rapidly dispatch-able within statistical probability projected database capacity to supply energy to typically a stationary user (though can also be mobility user) for a specified duration or amount of time.

“Energy storage device” refers to any device that is charged with energy for subsequent discharge of energy at a later time. The energy storage device can store either electricity (a.k.a. battery) or thermal energy (of which can be hot or cold).

“Environmental system” refers to the air flow within the portable host to regulate at least the temperature of the vehicle interior of the portable host. The environmental system is typically referred to as air conditioning or fresh air intake via the incoming air vent for the portable host.

“Expansion component” refers to the process where the pressure of the liquid refrigerant is rapidly reduced as it passes through an expansion device, typically an expansion valve. This pressure drop causes the refrigerant to expand, resulting in a mixture of liquid and vapor at a much lower temperature and pressure. A preferred expansion component is an expander, typically a turbine or similar component, that replaces the traditional throttling (expansion) valve to achieve the pressure drop of the refrigerant, but with the added benefit of extracting useful work from the expanding refrigerant.

“Exterior surface” refers to the outermost surface facing the external environment.

“External environment” refers to ambient conditions external of the control system and exemplary of external of the data center asset system.

“Feedback command” refers to an instruction that controls via any regulator based on real-time data, such as temperature or air flow rate, to maintain optimal operating conditions though prior to any adjustment by the feedforward command.

“Feedback comparator” refers to a control component that compares the current state of a controlled parameter from the point parameter set with a predetermined setpoint, and adjusts a regulator in accordance to the feedback command adjusted by the feedforward command.

“Feedback error” refers to a control action taken by the system to correct the difference between the desired and actual process conditions.

“Feedback loop” refers to a control mechanism that uses the output of the process or system to provide input to the same system, in order to regulate, stabilize, or correct its behavior, in this case, based on the feedback error.

“Feedback module” refers to a standard feedback loop that monitors and adjusts the process variables in real-time to optimize the performance and efficiency of the system.

“Feedback schedule database” refers to a plan or schedule for delivering a deployable asset and/or deployable cargo from one location to another, taking into account the current location, configuration, and routing of the asset, as well as any potential delays or disruptions. The feedback schedule database is based solely on current real-time known parameters selected from the group of point parameter sets and/or physical parameter sets.

“Feedforward and feedback loop control system” refers to the combination of controlling components first using a feedforward control system immediately followed by a feedback control system such that control parameters of the feedback control system are a function of the feedforward control system. For clarity, it is understood that the term control system is at least a feedback loop control system and preferably a feedforward and feedback loop control system.

“Feedforward command” refers to an instruction that controls at least one of any regulated parameters based on real-time data, such as temperature or flow rate, to maintain optimal operating conditions modifying the adjustment beyond by the feedback command.

“Feedforward comparator” refers to a control component that compares the current state of a controlled parameter from the point parameter set with a predetermined setpoint and feedforward inputs.

“Feedforward computational task” refers to a prediction or estimation of the system's response to a change and preferably tasks requiring computational capacity that are schedulable, typically made before the change occurs, to anticipate and adjust the control actions accordingly.

“Feedforward control system” refers to a control system that uses real-time measurements of the process variables to adjust the inputs to the process in order to maintain desired output, without relying on feedback from the process itself. Furthermore, it is a type of control system that takes preemptive action based on known or anticipated disturbances to improve system performance. It operates by directly manipulating the system's input using a model or prediction of how disturbances will impact the output, rather than reacting to the system's output after it has been affected.

“Feedforward inputs” refers to parameters or settings that directly influence the operational conditions of a system, such as the real-time actuator, which are used to control systems'operation in real-time yet looking proactively and not simply based on inputs of a typical feedback module.

“Feedforward modified command” refers to a control signal that is sent directly to the process or system being controlled, without going through a feedback loop, to modify the command or action being taken. In the context of the system, it would refer to a control signal that could directly modify any active parameter from the point parameter set.

“Feedforward module” refers to the feedforward and feedback loop control system that specifically addresses proactive modifications beyond a traditional feedback loop.

“Feedforward outputs” refers to any parameter of the point parameter set that regulates any regulator within the system to maintain a desired operating condition based on the combination of feedback command and adjustments made by executing the feedforward command.

“Feedforward schedule database” refers to a plan or schedule for delivering a deployable asset and/or deployable cargo from one location to another, taking into account the current location, configuration, and routing of the asset, as well as any potential delays or disruptions. The feedforward schedule database is based on current real-time known parameters and predictive models including parameters as a function of time and statistical probability projected database selected from the group of point parameter sets and/or physical parameter sets.

“Film” refers to preferably a polymeric material, though can be any material, providing at least a gaseous barrier across the thickness of the film.

“Fixed schedule database” refers to known and deterministic (as opposed to predictive or non-deterministic parameters) pre-defined schedules for deployable cargo and/or deployable assets, which are used to plan and organize the reconfiguration of deployable cargos and transportation by deployable assets between locations, in advance of the actual delivery and without taking into account real-time perturbations or parameter variations predicted by statistical probability projected databases.

“FLOPS” refers to Floating-Point Operations per Second, used interchangeably as FLOPS or FLOPS′ or FLOP, is a measure of a computer's ability to perform arithmetic calculations on real numbers. It is commonly used to evaluate performance in fields like scientific computing, machine learning, and data simulations, where precise and large-scale computations are required. FLOPS helps determine the raw computational power of processors and systems. Energy consumption per FLOPS specifically provides the ability to compare energy efficiency of computational asset.

“Flow direction” refers to the direction in which resources, such as airflow, electricity or data, flow through a system, typically from a source or producer to a consumer or user.

“Freeze crystallization system” refers to a process where saline or otherwise contaminated (e.g., organics, etc. as known in the art) water is cooled to below its freezing point, causing the at least purer water (now referred to as frozen clean water source) to crystallize as ice, while dissolved salts and other impurities remain in the liquid phase. The ice crystals are then separated from the concentrated brine, washed to remove any adhering salt, and subsequently melted to yield fresh water.

“Fresh air intake” refers to air that is drawn into the system from outside, typically through an air intake vent or duct to provide additional cooling and ventilation to the data center, particularly in the air-cooling system.

“Frozen clean water source” refers to water that has lower impurities (at least 2 percent less, preferably at least 50 percent, and particularly preferred at least 80 percent) relative to water upstream of the freeze crystallization system at a temperature below the freezing point of water.

“Greenhouse” refers to a physical space, at least partially isolated from atmospheric conditions, in which biological growth takes place as known in the art including the growing of food crops, agricultural crops, microalgae, and macroalgae that utilizes at least a portion of the solar spectrum for photosynthesis.

“Grid utility providers” refers to companies or organizations that provide electrical power and related services to customers, such as selling electricity, providing grid management, and facilitating the flow of energy within a grid or network.

“Heat pump” refers to a device that uses electricity (or mechanical energy when direct drive) to transfer heat from a colder area to a warmer one, effectively moving thermal energy rather than generating it. This process allows heat pumps to provide both heating and cooling. A heat pump system that incorporates a regenerative heat exchanger enhances system energy efficiency by reusing heat and reusing cool within the system and in the particularly preferred embodiment enabling the concurrent product of heating and cooling for an even higher system efficiency. In this context, “regenerative” refers to the use of a regenerator—a thermal transfer medium notably a regenerative heat exchanger that transfers thermal energy between two different places within the thermodynamic cycle of the heat pump.

“Heat rejection sink” refers to a component or system that dissipates or removes heat from a system or process through devices as known in the art (e.g., heat exchangers whether air-to-air, liquid-to-air, and liquid-to-liquid.

“Heat rejection temperature” refers to the temperature at which heat is rejected at the heat rejection sink.

“Heat source” refers to the thermal energy source in which heat is removed from, typically utilizing heat exchangers for indirect heat transfer or utilizing direct airflow or fluid-flow. In the context of the data center, the electronics that generate heat, such as the first partial data center electronics or second partial data center electronics.

“Heat transfer fluid” refers to a substance used to transfer thermal energy between a system and its surroundings or a refrigerant whether 1 phase or multiphase to transfer thermal energy between a first component of a system to a second component within the same system, often used in power generation systems, such as in the context of a power generation system, to enhance efficiency by transferring waste heat to a secondary circuit.

“High energy efficiency and high utilization asset system” refers to a mechanism that enables the dynamic reconfiguration of deployable assets, such as deployable motors or deployable cargos, at designated data centers, by rapidly changing their physical parameters, in order to optimize their deployment, functionality, or transportation between multiple locations.

“High-side pressure” refers to portion of a thermodynamic cycle downstream of a compressor, therefore having a pressure higher than the low-side pressure upstream of the compressor.

“Horizontal structure” refers to a physical structure that is predominantly, though preferred to be absolutely, parallel to the ground capable of supporting at least both lateral and dead loads, and preferably also live loads.

“Host community” refers to a specific community (or consumer) receiving direct benefits from within a network of dedicated non-pooled assets at a first location to benefiting from pooled assets at proximity locations where tasks can be dynamically allocated, allowing for efficient use of resources and optimization of asset utilization, often integrated with the asset queuing system.

“Immersion cooling system” refers to a type of cooling system in which electronic components, such as those in a data center, are submerged in a liquid coolant, typically a dielectric fluid, that is in direct thermal contact with the components.

“Integral gaseous storage” refers to an integrated storage capability within an enclosed containment area that is isolated from atmospheric environmental conditions, with exemplary storage examples of the interior of greenhouse or radiative cooling system, that stores gases notably carbon dioxide exhaust source.

“Internal volume” refers to the total available space inside an enclosure before components are installed, such as the printed circuit boards.

“Internet” refers to a global network of interconnected computers and servers that use standardized communication protocols to exchange information, facilitating access to a vast array of resources, services, and data.

“Liquid cooling system” refers to a liquid-based cooling method where a heat transfer fluid, typically a coolant or a dielectric fluid particularly when the liquid cooling system is of an immersion cooling system type, is circulated through a system to absorb and dissipate heat from electronic components, in contrast to traditional air-based cooling methods.

“Low-side pressure” refers to refers to portion of a thermodynamic cycle upstream of a compressor, therefore having a pressure lower than the low-side high-side pressure downstream of the compressor.

“Mechanical vapor recompression system” refers to a type of cooling system that utilizes a refrigerant to transfer heat from a cooling fluid to a vapor, which is then compressed to increase its temperature, and condensed to absorb heat from a second fluid, typically air or water, to achieve a cooling effect. The preferred embodiment of the heat exchangers are regenerative heat exchangers, as known in the art, such that both heating is provided immediately downstream of the compressor and cooling is provided immediately downstream of the expansion component. It is understood that the term mechanical vapor recompression system is interchangeable with the term heat pump, and the preferred embodiment of a regenerative heat pump that utilizes a regenerative heat exchanger. The data center centric preferred embodiment is a regenerative heat pump, while the co-located process centric embodiment is a mechanical vapor recompression system having a regenerative heat exchanger.

“Meta sensor” refers to a calculated function that is typically calibrated or measured on a previous set of data preferably utilizing machine learning to prevent the necessity for expensive or impossible to determine from direct measurement of based on point parameter set and/or physical parameter set. It is understood that a meta sensor can be used to replace any physically measured amount of from the point parameter set. In fact, the actual term of a real-time parametric value can interchangeably be a calculated and projected value as determined by a minimum viable set of operating conditions in which prior training has taken place.

“Microgrid” refers to a distributed electrical grid that can function autonomously or in parallel with a larger, main grid, managing energy distribution and consumption at a local level, often incorporating multiple sources of power, such as renewable energy, and utilizing advanced control systems to optimize energy flow and management. The preferred embodiment is such that the sources are behind-the-meter.

“Multi-wall carbon nanotubes”, also referred to as “mwcnts” refers to nanotube structures composed of a multiple sheets of carbon atoms, typically with internal diameters of 1-10 nanometers, exhibiting high surface area, electrical conductivity, and thermal resistance, and used in various applications such as energy storage, composites, and electronics.

“Non-solar-facing side” refers to the opposite facing side of the solar-facing side, meaning direct exposure from the sun will not occur.

“On-site demand” refers to the demand for resources or services at the specific location including first locations or proximity locations.

“Operational byproduct” refers to a secondary or residual product generated during the operation of an asset, such as electricity or heat, which can be utilized to generate revenue or improve the efficiency of the asset. In the instance of fuel being methane post a methane pyrolysis component the byproduct includes carbon products most preferred as known in the art as carbon nanotubes including multi-wall carbon nanotubes “mwcnts”.

“Perishable capacity” refers to the available instantaneous capacity of a system or asset to perform tasks or provide services and therefore create value, such that failure to fully perform tasks matching the instantaneous capacity effectively at that precise time forever fails to create value during that time period hence it is perishable (unable to create future value).

“Personal contribution task value” refers to the economic value assigned to a task contributed by an individual person (or individual group of people) in which the beneficiary is a 3rd party (i.e., not the person enabling an operational task to be completed).

“Personal utilization task value” refers to the economic value assigned to a task utilized or consumed by an individual person (or individual group of people) as beneficiary in which the task was performed or made available by a 3rd party (i.e., not the person benefiting from the operational task completed).

“Phase change material slurry” refers to a mixture of a phase change material (PCM) and a liquid carrier, typically a slurry, used to improve the thermal performance and energy storage capabilities of an asset or system, such as an immersion cooling system.

“Physical parameter set” refers to a minimum set of individual parameters characterizing physical metrics, particularly physical metrics that are a function within the control system having a point parameter set.

“Plant” refers to in this context any cultivated organism grown within the controlled environment of the greenhouse for purposes including fruit, vegetable, flower, ornamental or energy crop production.

“Plurality of parameters” refers to multiple values or conditions that are simultaneously considered in a control system, in this context, referring to the combined effect of various temperature parameters, sensors, and control estimates such as on the target temperature setpoint.

“Plurality of sensors” refers to multiple sensors such as sensors that provide temperature or relative humidity measurements, often used to monitor the physical conditions within the different components or systems of the data center, greenhouse or any co-located processes that are in direct or indirect thermal or electrical communications with the data center.

“Point parameter set” refers to a minimum set of individual parameters for regulating control of any variable condition included by the control system as a function of real-time operating conditions consisting of at least two of meta sensor or actual sensor measuring a physical data point specific to the physical point in which the actual sensor is placed. The set of individual parameters can include a minimum and maximum real-time air flow rate, and a minimum and maximum real-time temperature.

“Pooled asset” refers to a collection of assets that are shared and managed together, often with the goal of increasing efficiency, reducing costs, and improving utilization. In the context of the asset queuing system, pooled assets are assets that are dynamically reallocated to optimize task execution and revenue generation and most often utilizing dynamic addressing between a first location and an at least one proximity location.

“Power generation system” refers to the aggregate of a compression stage, a combustion stage (or thermal input), and expansion stage to create mechanical and/or electrical energy. It is a fundamental goal of a power generation system that integrates the external combustor with all the external combustion system components including combustor component set and non-combustor component set.

“Primary asset task” refers to a task performed on an asset where the task is within the set of primary purpose in which the asset was acquired. One exemplary is a GPU operating on an autonomous vehicle for the primary purpose of the vehicle arriving safely at its destination, yet it is understood that when the autonomous vehicle is not traveling the GPU has excess computational capacity in which it could perform a secondary asset task inclusive of machine learning analysis for weather predicting for a proximity location.

“Primary depreciation function” refers to typically standard accounting methods for depreciation rate is based on the asset performing a primary asset task acquisition price amortized based on the anticipated operating asset's lifetime.

“Printed circuit board” refers to a physical substrate, typically made of a non-conductive material, bearing electronic components and connections, used to support and interconnect electronic circuits inclusive of microprocessors, memory, and power conversion/regulation.

“Prioritization response system” refers to a deterministic or non-deterministic (e.g., heuristic or machine learning) system establishing rules and algorithms to vary dynamic routing system at a minimum, and preferably also dynamic addressing, dynamic pricing system, and dynamic height adjustment system realizing a numerical prioritization amongst locations within at least one location candidate set. A resulting routing schedule is established by the dynamic routing system for each deployable asset and deployable cargo.

“Proximity location” refers to a specific geographic area or region, defined by its spatial relationship to other locations such as a first location. In virtually all instances a proximity location has temporary placement of pooled assets.

“Rack” refers to a physical enclosure or unit that holds and supports multiple servers, computers, or other computing devices, typically in a data center or similar environment.

“Radiative cooling system” refers to a passive cooling technology where specially engineered coatings or paints reduce the temperature of surfaces by two main mechanisms 1) reflecting incoming solar radiation and 2) emitting thermal radiation through the atmospheric “sky window”.

“Regenerative heat exchanger” refers to a heat exchanger that maximizes energy efficiency by capturing and reusing heat downstream of the compressor and a heat rejection sink in order to preheat vapor (i.e., refrigerant) that is upstream of both the compressor and an external heat source.

“Regenerative thermodynamic cycle” refers to a thermodynamic cycle that has both a high-side pressure and a low-side pressure, typically utilizing a compressor to establish the pressure differential between from the low-side pressure to the high-side pressure, and at least one regenerative heat exchanger that reuses excess available thermal energy from the high-side pressure within the low-side pressure. The regenerative thermodynamic cycle is either a mechanical vapor recompression system or heat pump system. Additional heat exchangers for additional heating and/or additional cooling are anticipated for optimal performance beyond the traditional condenser and evaporator.

“Relative humidity” refers to the ratio of the partial pressure of water vapor in the air to the partial pressure of saturated water vapor at a given temperature, often expressed as a percentage.

“Roof” refers to an uppermost covering of a building or structure. It includes all materials and constructions necessary to support it on the walls or uprights of the building (e.g., biomass growing facility), serving as a protective barrier against external weather elements such as rain, snow, wind, and extremes of temperature (not sunlight for the portion that is a greenhouse).

“Secondary asset task” refers to a task performed on an asset where the task is external of the set of primary purpose in which the asset was acquired. One exemplary is a GPU operating on an autonomous vehicle for the primary purpose of the vehicle arriving safely at its destination, yet it is understood that when the autonomous vehicle is not traveling the GPU has excess computational capacity in which it could perform a secondary asset task inclusive of machine learning analysis for weather predicting for a proximity location.

“Secondary depreciation function” refers to typically standard accounting methods for depreciation rate is based on the asset performing a secondary asset task replacement value amortized based on the anticipated operating asset's lifetime.

“Setpoint” refers to a predetermined parametric value that serves as a target or reference point for controlling the active parameter.

“Solar-facing side” refers to the side of a data center that receives direct sunlight or illumination from the sun, typically on the exterior or roof side of the building.

“Solicited made available” refers to made available or offered by the system in response to a request or inquiry from another node or entity, typically in the context of resource allocation or task assignment, such as a request to execute a computational task or to provide electricity.

“Solid-state electronic” refers to equipment or devices that utilize semiconductors, such as integrated circuits, to perform its designed function, as opposed to traditional mechanical components like fans.

“Statistical probability projected database” refers to a database of parameters, preferably as a function of time, in which the predicted values account for statistical probabilities of at least one parameter (and preferably all parameters that are not fixed in time). Within the context of this system, the statistical probability projected database includes predicted inventory control database based on actual operating hours of a deployable asset and its deployable cargos relative to its anticipated lifetime hours (or maintenance interval), based on predictive weather that can impact parameters including feedforward schedule databases, energy demand profile, energy storage capacity, feedforward computational tasks, and reverse logistics tasks.

“Structural cable” refers to a cable (a.k.a. structural wire) that is embedded in a structure, such as at least in the major roof section of the co-location facilities, that acts as a primary load-bearing element by carrying forces exclusively in tension.

“Temperature” refers to a physical quantity that is a measure of the degree of hotness or coldness of an object or substance.

“Thermal energy quality” refers to how easily a form of energy can be converted into useful work. High-quality energy, such as mechanical, electrical, or chemical energy, can be efficiently transformed into other forms or used to perform tasks with minimal losses. In contrast, low-quality energy is less convertible and less effective for performing work. Thermal energy is generally considered a low-quality form of energy, in which as used in this invention, specifically includes a broader definition of how easily the energy (i.e., higher temperatures) can be utilized in secondary processes (and not just useful work). This is because, while all work can be converted to heat with nearly 100% efficiency, the reverse is not true: only a fraction of thermal energy can be converted back into work. The limitation is dictated by the second law of thermodynamics and the concept of entropy, which measures the disorder in a system. As entropy increases, the quality of energy decreases, making it less useful for performing work. A higher quality of thermal energy has a higher exergy compared to a lower quality of thermal energy.

“Thermally activated system” refers to a system that utilizes resulting heat by combustion of fuel within a combustor, in the context of this invention within the external combustor and the broader range of interconnected devices within the combustor component set. It is recognized in the art that this includes power generation system, environmental system (e.g., air conditioning, heat pumps, boilers, etc.), and processes (e.g., drying, washing, cooking, etc.).

“Time” refers to In the context of data center asset systems, “time” refers to a scheduling parameter used to establish a delivery schedule of deployable assets, specifically a time window or interval during which a deployable asset and/or deployable cargo is expected to be transported from one location to another in addition to a time window or interval during which the deployable cargo will be utilized at a location, and in addition to a time window or interval during which the deployable asset will be docking at a location's docking port (i.e., the deployable cargo is not yet available to perform its function for a stationary user) or a time window or interval during which the deployable cargo is at the data center (i.e., the deployable cargo is not yet available to perform its function for a mobility user).

“Transpiration” refers to the process by which water is lost from plants in the form of water vapor, primarily through small openings called stomata located on the surfaces of leaves, but also through other aerial parts such as stems and flowers. This process involves the movement of water absorbed by the roots, which travels upward through the plant and eventually evaporates into the atmosphere from these aerial surfaces.

“Unsolicited made available” refers to the provision of a resource or service without prior request or negotiation, often in a dynamic or adaptive manner, such as in a cloud computing or energy trading platform.

“Utilization adjustment ratio” refers to ratio of actual utilization of an asset to its maximum potential utilization, used to dynamically adjust pricing and resource allocation in an asset queuing system.

“Variation of time of day or seasonal” refers to changes in at least one parameter of physical parameter set or point parameter set that varies as a function of time, whether that time is based on a time of day, a day of the year, or otherwise seasonal changes as known in the art. The anticipated variations include inventory control database, statistical probability projected database, fixed schedule database.

“Velocity regulator” refers to a control system or component that adjusts the rate or speed of an airflow or fluid.

“Waste heat” refers to thermal energy that is generated as a byproduct of an asset's operation, such as electricity generation or data processing, which can be leveraged to generate revenue through valorization or utilization.

“Water treatment facility” refers to an engineered plant or system designed to remove salts, minerals, and other impurities—including organic contaminants—from water sources such as seawater or brackish water, making the water suitable for human consumption, irrigation, or industrial uses.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrates the feedforward control system preferably utilized for control of the regenerative thermodynamic cycle within the co-location facility.

FIG. 2 illustrates structural advantages within the interior of the co-location facility, and thermal communications between the various components within the co-location facility.

FIG. 3 illustrates structural advantages extending into the adjacent exterior of the co-location facility.

FIG. 4 illustrates the overall features of the co-location facility including the integral storage advantages within the interior of the co-location facility.

FIG. 5 illustrates an ultra-compact data center asset system with decoupled power generation systems for independent deployment between proximity locations.

FIG. 6 illustrates a data center asset system with decoupled power generation system and waste heat upgrading system for thermal management within proximity locations.

FIG. 7 illustrates an asset queuing system for both computational tasks to be routed on computational asset within at least one proximity location without requiring any physical logistics and power generation systems within at least one proximity location requiring physical logistics.

FIG. 8 illustrates a billing system for both primary asset task and operational byproducts.

FIG. 9 illustrates asset decoupling from first proximity location to second proximity location.

### DETAILED DESCRIPTION

Here, as well as elsewhere in the specification and claims, individual numerical values and/or individual range limits can be combined to form non-disclosed ranges. Exemplary embodiments of the present invention are provided, which reference the contained figures. Such embodiments are merely exemplary in nature. Various embodiments of the disclosure are discussed in detail below. While specific implementations are discussed, this is done for illustration purposes only. A person skilled in the relevant art will recognize that other components and configurations may be used without parting from the spirit and scope of the disclosure.

Regarding the figures, like reference numerals refer to like parts. As used herein the term “substantially” is used to indicate that exact values are not necessarily attainable especially when the point parameter set is a function of the parameters within the statistical probability projected database. In some embodiments of the present invention, the term “substantially” is defined as approaching a specific numeric value or target to within 20%, 15%, 10%, 5%, or within 1 % of the value or target. In further embodiments of the present invention, the term “substantially” is defined as approaching a specific numeric value or target to within 1 %, 0.9%, 0.8%, 0.7%, 0.6%, 0.5%, 0.4%, 0.3%, 0.2%, or 0.1 % of the value or target. As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to +20%, +15%, +10%, +5%, or +1 % of a specific numeric value or target. In some embodiments of the present invention, the term “about” is used to indicate an uncertainty limit of less than or equal to +1 %, +0.9%, +0.8%, +0.7%, +0.6%, +0.5%, +0.4%, +0.3%, +0.2%, or +0.1 % of a specific numeric value or target. {Alternatively—As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within I or more than I standard deviation, per the practice in the art. “About” can mean a range of ±20%, ±10%, ±5%, or ±I% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.}

In some embodiments of the present invention, the term “continuum” is defined as an effective continuous function for a specific numeric range such that a continuum from 1 to 2 includes exemplary values of approximately 1.01, 1.02, 1.03 continuing through 1.97, 1.98, 1.99 to 2.0. In the context of a ratio with exemplary of X:Y being 1:1 to 1:2 it ranges from 50% of X and 50% of Y through approximately 33% of X and 66% of Y therefore it includes exemplary ratios of 1:1.2, 1:1.3, etc. that being effectively equivalent of a continuum of 2:2 to 2:4. As used herein, the term “optional” or “optionally” means that the subsequently described event or circumstance can or cannot occur, and that the description includes instances where the event or circumstance occurs and instances where it does not. It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms. However, the identifiers “next” is intended to imply a particular order and importance to the components or steps modified by this term. To further clarify, next specifically implies when associated with a first instance is prior to the next second instance with respect to time sequence (recognizing that often a first instance can be followed not only by a second instance but also a third or even fourth instance) such that next explicitly implies that the step is realized for the first instance prior to the second instance (or third instance). The identifiers “previous” and “prior” is intended to imply a particular order and importance to the components or steps modified by this term. To further clarify, previous specifically implies when associated with a previous first instance is prior to the second instance with respect to time sequence (recognizing that often a third instance can be preceded not only by a second instance but also a first instance) such that previous (or prior) explicitly implies that the step is realized for the first instance prior to the second instance (or third instance).

The following is a general description of the distributed and dynamic queuing system that preferentially also includes the previously filed inventive immersion cooling system particularly within an embodiment where a first co-located process is a data center with a second co-located process being a water treatment facility, biomass growing facility, or virtually any industrial process having peak operating temperatures less than 200 degrees Celsius (and preferred less than 180 degrees Celsius, particularly preferred less than 160 degrees Celsius, and specifically preferred less than 120 degrees Celsius) for reference, as the valorization of waste heat from a first process to a second process is a key exemplary of establishing operational byproduct revenue such that the deployment of the distributed and dynamic queuing system is not based solely on the primary asset task revenue. In fact due to the operational byproduct revenue, it is an inventive feature of the system to dynamically modify the pricing of the primary asset task revenue such that the aggregate revenue being the summation of operational byproduct revenue plus primary asset task revenue plus aggregate of valorization value to host communities and proximity locations is optimized preferably on a feedforward basis. It is a fundamental feature of the distributed and dynamic queuing system that both the performing primary asset task and the designation of the location in which those primary asset task are performed, especially for a computational asset and power generation systems both having perishable capacity, is optimized not solely for the benefits of the owner of the computational asset and power generation systems. This fundamental feature is at the heart of reducing the aggregate of all expenses associated with the ownership of computational asset and power generation systems with exemplary line items off of the income statement including co-location of computational asset and power generation systems at a proximity location (that being any facility not wholly owned by the primary owner of the computational asset and power generation systems) therefore the computational asset and power generation systems can be permanently or temporarily located without requiring a rental fee (or at least a submarket value rental fee). Another exemplary line item of the income statement can include permanently or temporarily located without requiring a fuel or power generation fee (or at least a submarket value fuel or power generation fee) this being particularly important as the assets continue to improve in terms of energy efficiency and/or the operational byproduct valorization exceeds the incremental fuel or power generation fee.

The second co-located processes can further include biofuels, pulping, sugar, industrial processes notably drying, and mineral extraction conversion processes. The preferred water treatment facility particularly utilizes a cooling side having freeze crystallization system for removing water impurities whether for clean water purposes (including salt removal from brackish water), water reutilization, or primary production of ingredients (e.g., sugars, foods, pulp, etc.) or salts) with the particularly preferred embodiment of the residual frozen clean water source (i.e., ice) being used for data center cooling. On-site power generation system, as known in the art, produces waste heat that is preferably utilized to increase the heat rejection temperature downstream of the compressor within the mechanical vapor recompression system or heat pump system. In the event, which is typical of single-cycle power generation systems, that the waste heat source exceeds 200 degrees Celsius it is optimally used also to pre-heat combustion air within the power generation system. A second mechanical vapor recompression system or heat pump system is preferably utilized for both waste heat recovery and water recovery (through condensation recovery of water vapors) such that recovered water is utilized to pre-cool that downstream portion of the first mechanical vapor recompression system or heat pump system expansion component for additional cooling of the air-cooling system within the data center.

The preferred utilization of the freeze crystallization system decouples top-cycle heat generation from mechanical vapor recompression system or heat pump system (preferably from immersion cooling system of the data center, though any waste heat from a first co-located process) and the utilization of bottom-cycle cooling (preferably to air-cooling system of the data center, though any cooling required in a second co-located process). One of the preferred embodiments for a second co-located process is biomass to biofuels conversion, as the least valuable portion of the biomass can be utilized as a fuel of the power generation system. Particularly the biofuels integration utilizes the freeze crystallization system to concentrate residuals from the aqueous residual stream of as known in the art biomass conversion processes. A preferred aqueous result from biomass conversion processes having operating temperatures of less than 200 degrees Celsius (and preferred less than 160 degrees Celsius, particularly preferred less than 150 degrees Celsius, and specifically preferred less than 120 degrees Celsius). The ability to utilize the waste heat from the data center regardless of variations of time of day or seasonal enhances the data center energy efficiency (i.e., first co-located process) and mechanical vapor recompression system utilization (rejecting waste heat downstream of compressor) to second co-located process. A specifically preferred embodiment is a data center as a first co-located process, a biomass conversion facility with a peak operating temperature as noted below 200 degrees Celsius as a second co-located process, and a biomass growing facility as a third co-located process. This embodiment utilizes waste heat from the data center even when as known in the art fresh air intake (i.e., atmospheric cooling) would otherwise be utilized, frozen clean water source from the freeze crystallization system reduces airflow within the air-moving devices of the air-cooling system by cooling the air temperature below the fresh air intake temperature especially during peak data center operations.

In terms of the data center, maximizing the utilization of waste heat requires achieving the a higher thermal energy quality (i.e., a higher temperature for a higher exergy) and therefore a fundamental aspect of the invention is to thermally isolate a relatively higher temperature heat source from a relatively lower temperature heat source so as to prevent mixing of the two respective heat sources. Mixing the waste heat directly from microprocessors within a data center (e.g., server, or even power conversion devices) from other waste heat from secondary components around the microprocessors reduces the thermal energy quality of the aggregate waste heat, which greatly diminishes the waste heat's usefulness to most other processes. The utilization of immersion cooling system, as known in the art, reduces cooling requirements for data centers but more importantly in this inventive use the immersion cooling system thermally isolates the air-cooling system (at least the most significant percentage of cooling requirement (greater than 50 percent, preferably greater than 60 percent, or particularly preferred greater than 65 percent of the data center cooling requirements) such that the waste heat has higher thermal energy quality. And when immersion cooling system waste heat is utilized by a mechanical vapor recompression system or heat pump system configured with a regenerative heat exchanger it provides the inventive waste heat for a co-located process while also achieving cooling of the air-cooling system. The thermal isolation of the immersion cooling system from the air-cooling system also enables the waste heat from the mechanical vapor recompression system or heat pump system (specifically the compressor serves both a higher exergy downstream of the compressor to any thermally activated system concurrently with air-cooling system to the data center downstream of the expansion component including to be utilized to drive an absorption or adsorption chiller for the air-cooling system) leveraging the thermal isolation of the immersion cooling system from the air-cooling system. Without the thermal isolation, insufficient waste heat utilization is achieved as the thermal energy quality is too low (i.e., exergy downstream of the compressor is at least 1 percent greater, preferably at least 2 percent greater, particularly preferred at least 5 percent greater, and specifically preferred at least 10 percent greater) as compared to with the thermal isolation between the immersion cooling system (i.e., high-side pressure of regenerative thermodynamic cycle) and air-cooling system (i.e., low-side pressure of regenerative thermodynamic cycle).

The biomass growing facility increases the energy efficiency of the air-cooling system such that water now within the airflow has higher relative humidity via biomass (i.e., plant) transpiration which increases the heat capacity of data center air-cooling system (and therefore reduces airflow speed created by the air-moving devices, leading to reduced energy consumption of the air-moving devices). The data center air-cooling system operates analogous to a heat pipe energy recovery loop, thus performing the active dehumidification of biomass growing facility (a.k.a. greenhouse) air. The biomass growing facility and data center operations combine to close the loop on water recovery and reuse especially when the mechanical vapor recompression system or heat pump system utilizes the common air of the air-cooling system of the data center and the biomass growing facility. In the particularly preferred embodiment of further biomass to biofuels transformation as third co-located process the higher temperature downstream of the compressor within the mechanical vapor recompression system or heat pump system is utilized to preheat the biomass upstream of the biomass to biofuels conversion process which leads to water condensation (as water recovery of transpired water vapor within the biomass growing facility). A preferred relative humidity is greater than 55 percent with a data center air cooling system temperature greater than 20 degrees Celsius (preferably greater than 22 degrees Celsius, particularly preferred greater than 24 degrees Celsius). In this manner, the biomass growing facility achieves a more optimal growing environmental system of the biomass growing facility and further leverages a radiative cooling system (also co-located with both the immersion cooling system and the air-cooling system of the data center). Integration of the airflows between the data center and the biomass growing facility reduces the energy inputs as compared to two distinct and isolated airflows of the data center and of the biomass growing facility. One noted advantage is that the momentum required for adequate air-cooling system within the data center is then utilized advantageously within the biomass growing facility (creating “wind” that yields more crisp leafy greens) without requiring a second set of air-moving devices dedicated to the biomass growing facility.

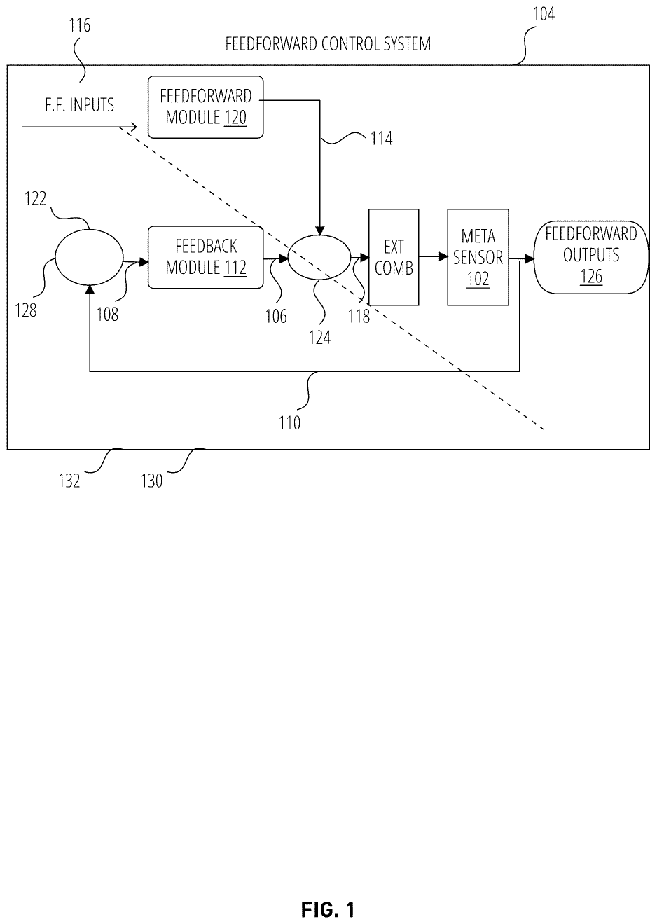

The optimal growing conditions within the biomass growing facility are a function of the crop being grown (which is variable throughout the day, particularly when the biomass growing facility is a greenhouse as compared to a vertical farm (which is less subject to natural sunlight availability). As such the further described within FIG. 1 feedforward and feedback loop control system 130 operates as a function of both the data center (first co-located process) and the biomass growing facility (second co-located process) and optionally a third co-located process (e.g., biomass to biofuels transformation, water treatment facility, etc.). Operating at a cooler temperature and higher relative humidity within the biomass growing facility achieves closer to optimal temperature range for most leafy greens (including lettuce, spinach, kale, and similar crops) of 12-18 degrees Celsius. The subsequent optimal airflow into the data center, by way of increasing its temperature thus “cooling” within the air-cooling system, decreases the effective relative humidity thus operating closer to the data center normal range. It is particularly preferred to have a relative humidity higher than 60 percent within the biomass growing facility and below 80 percent within the data center (more preferred less than 70 percent and specifically preferred less than 60 percent).

An additional co-located process includes the heat rejection sink of the mechanical vapor recompression system or heat pump system downstream of the compressor being utilized for regeneration of absorbents or adsorbents including carbon dioxide “CO2”, water (preferably liquid desiccant regenerator) therefore enabling a lower CO2 footprint for the data center when an on-site power generation system provides at least a portion of the electricity required by the data center. The utilization of on-site CO2 storage (even when temporary) is an important aspect of the invention, as on-site power generation system that combusts a fuel is substantially more likely to operate during offsetting times of on-site biomass growing facility photosynthesis periods. In other words, a CO2 adsorbent or absorbent optimally regenerates predominantly when on-site (or even grid) renewable electricity is available (i.e., no CO2 is produced), and the desorbed CO2 is then consumed by co-located biomass growing facility to enhance the growth rate as known in the art. The result is CO2 decoupling between the power generation system and the biomass growing facility, and therefore waste heat from the power generation system is not available (unless it is stored) in order to regenerate the CO2 adsorbent or absorbent. Likewise, this decoupling of dehumidification regeneration is also desired as plants via transpiration require more available water during periods of photosynthesis (which again is offset in most instances from power generation system operations). Mechanical vapor recompression system or heat pump system peak heat rejection temperature required for regeneration is less than 120 degrees Celsius (and preferred less than 100 degrees Celsius and particularly preferred less than 80 degrees Celsius.

Biomass conversion/production creates water soluble byproduct as a result of hydrolysis, such that freeze crystallization system can enhance water reuse and reduce wastewater treatment otherwise necessary. The further combination of a dual electrolyzer, in which organic chemical energy contributes to hydrogen byproduct production such as to be used for power generation system to support the data center electricity requirements, further supports the inventive co-location facility of the data center and biomass processing with on resulting water phase provides for hydrogen into data center power generation systems while enhancing the reuse of water with residual acetic acid (and other carboxylic acids) particularly for low-temperature HCl utilization of hemicellulose hydrolysis. Without the data center co-location facility cooling as provided by freeze crystallization system would be an underutilized thermal benefit. Alternatively, the pre-heating of resulting aqueous stream by MVR downstream of data center enhances HCl recovery as well as water distillation (resulting in organic concentration for dual electrolyzer). Pre-heating of biomass for subsequent hydrothermal liquefaction is another candidate co-location facility process, though lower temperature liquefaction processes are superior. As such waste heat from hydrothermal liquefaction can increase the thermal energy quality by further heating to an increased temperature beyond the immersion cooling system discharge temperature (i.e., heat rejection temperature). Preferred biomass liquefaction processes utilize the following solvents (referencing boiling point in parentheses) for pre-treatment as selected from tetrahydrofuran “THF” (66 C), ethanol (78.23 C), methyltetrahydrofuran “MTHF” (80.2 C), or 2-pentanol (119.3 C) in order of preference, all having distillation temperatures less than the mechanical vapor recompression system peak or heat pump system heat rejection temperature (i.e., downstream of compressor). The addition of protic compounds notably acetic acid and formic acid within the biomass liquefaction is particularly preferred. Protic compounds are chemical substances that contain a hydrogen atom bonded to a highly electronegative atom, such as oxygen, nitrogen, or, less commonly, fluorine. This bond (e.g., O—H or N—H) allows the compound to act as a hydrogen bond donor and, crucially, to donate a proton (H⁺) in chemical reactions. Biomass processing virtually always creates excess water that most often requires wastewater water treatment facility. The co-location facility with the data center when combined with vacuum thermal distillation provides clean water for evaporative cooling into the air-cooling system of the data center, in which case both water disposal/treatment costs are reduced as well as water consumption and cooling electricity requirement. When the biomass growing facility has artificial lighting, as known in the art to include LED lighting optimally preferentially arranged as a liquid-cooled LED array, is analogous in terms of immersion cooling system as a heat source to the mechanical vapor recompression system or heat pump system upstream of the compressor(s). The inventive arrangement is anticipated also for a second co-located process including desalination (thermal/freeze crystallization system), mineral extraction and/or mineral concentration.

Virtually any additional thermal heat source can supplement the waste heat source of the immersion cooling system such that either additional thermal energy is available, or a higher thermal energy quality is realized. This includes separate on-site air conditioning systems or air compressors (i.e., any system that generates heat of compression due to compressor operations), solar thermal panels, waste heat from solar photovoltaic panels, etc. The expansion component of the mechanical vapor recompression system or heat pump system is preferred to have energy recovery (i.e., rotation of expander generates mechanical energy, which can reduce energy required by compressor of the mechanical vapor recompression system or heat pump system or for direct-drive of a secondary compressor for either heat pump operations or air conditioning operations). Another advantage of on-site and co-location facility of biomass fuel production enables the data center to be direct current “DC” microgrid operations, as the biomass processing facility provides a green combustible fuel for power generation system it also utilizes waste heat from mechanical vapor recompression system or heat pump system and provides lower thermal energy quality waste heat to pre-heat via regenerative heat exchanger upstream of the compressor. This on-demand power generation system combined with intermittent renewables being entirely DC reduces power conversion losses and now unnecessary inverter or power conversion equipment.

The previous sections feature thermal integration between co-location facilities notably data center (a first co-location facility) and at least one of biomass growing facility and water treatment facility (a second co-location facility). The fundamental thermal integration is via mechanical vapor recompression system or heat pump system. Many of the subsequent details extend inventive features beyond thermal integration notably structural integration and more preferred multi-functional structural elements that serve a structural function in the first co-location facility and a non-structural function in the second co-location facility. Furthermore, excess structural capacity within the first co-location facility is utilized to reduce the otherwise structural capacity needed for the second co-location facility especially when the second co-location facility is a biomass growing facility (and preferably when it is a greenhouse). The control system monitors weather conditions (e.g., wind speed and direction, snow or ice loads) in order to regulate and coordinate 2-dimensional “2D” movement and structural loading within the biomass growing facility to ensure that the excess structural capacity of the first co-location facility is not exceeded by the structural requirement of the 2D movement system (preferably when the aforementioned weather conditions create temporary structural loads). The 2D movement structure supports both planting and harvesting equipment of plants within the biomass growing facility, such that the preferred 2D movement structure serves as structural support for the air-moving device within the data center air-cooling system. The preferred air-moving devices are in between structural columns to enable switching of airflow direction from either the first co-location facility to the second co-location facility or vice versa from the second co-location facility to the first co-location facility. The position of the air-moving devices is in a vertical orientation and does not interfere with the 2D movement structure supporting the planting and harvesting equipment (except for the transition of flow direction). The continuity of airflow between the first co-location facility in particular to the second co-location facility reduces the airflow energy requirements (by at least 2 percent, preferably by at least 5 percent, and specifically preferred by at least 10 percent) as compared to distinct and individual air-moving devices serving each of the co-location facilities. A data center (i.e., first co-location facility) has airflow rates required for thermal management within the air-cooling system by at least 10 percent higher than the airflow rates required for both thermal management (and preferably also to strengthen the plants).

Furthermore the 2D movement structure is of a height (at least 1 inch, preferably at least 3 inches, and particularly preferred at least 3 inches higher than the peak plant growing height) to prevent the planting and harvesting equipment primary motive wheels (in structural communications with the 2D movement structure) from touching the ground (which is in structural communications with at least a portion of the plants within the biomass growing facility. The first co-location facility has a peak height that exceeds the second co-location facility, such that the peak height provides physical support for the second co-location facility and that the thermal energy from the first co-location facility is utilized to provide thermal energy to the second co-location facility to reduce ice or snow adhesion to the second co-location facility roof. The particularly preferred structural support for the second co-location facility roof is a cable element that is preferably has a partially vertical angled orientation, with the preferred cable element having a foam element between the cable element and the roof. The vertical angled orientation reduces ice and snow adhesion strength (by at least 5 percent, preferably by at least 20 percent, and specifically preferred by at least 50 percent) to the roof as compared to a predominantly horizontal orientation cable element. Another preferred structural feature is that a horizontal orientation structural element for the second co-location facility also serves as a liquid carrier for the fire sprinkler system of the first co-location facility. This is possible as the waste heat source within the first co-location facility prevents the potential for pipe freezing conditions due to environmental exposure within the second co-location facility. The particularly preferred horizontal orientation structural element has the liquid within the internal portion of the horizontal orientation structural element being water (including with nutrients) so as to reduce the necessity for a dedicated horizontal mainline water distribution system to the plants within the biomass growing facility. The control system prevents water distribution within the biomass growing facility during an actual fire safety event (or optionally and preferred during higher probability times in which a fire event could occur). Additional multi-functional purposes include liquid carrier in thermal communications with the radiative cooling system on the non-solar-facing side of the first co-location facility (i.e., data center). Airflow ducting between the first co-location facility and the second co-location facility preferably serves as an additional structural element to the second co-location facility roof, such that airflow is internal of the additional structural element.

The combination of the first co-location facility and the second co-location facility further isolates noise created from the first co-location facility (particularly data center) impacting an extended zone beyond both the first and second co-location facilities. The particularly preferred data center has a length to width ratio is at least 2:1 (and preferably at least 5:1 and specifically preferred at least 10:1). In the context of co-location facilities, especially when the facilities are in close proximity to additional co-location facilities (e.g., residential, retail, or workplaces), both noise isolation (or shielding) and traffic segmentation is strongly desired. The particular length to width ratio of greater than 10:1 is a fundamental advantage for sound shielding for any activity taking place on the opposite width side of the first co-location facility. Furthermore, the physical height and the long length of the first co-location have an important benefit beyond the second co-location, notably the utilization of the raised structure serving as a landing strip for flying vehicles (e.g., drones, air taxis, etc.). The height of the facility provides increased visibility to the flying vehicles, and importantly isolation to any ground-based vehicles or people. As vehicles transition to electrified vehicles, the power generation system of the data center (which can be used as primary power source, or as backup power source) serves by way of co-location facility to electric vehicle charging power source directly or indirectly to swappable batteries first and then to electric vehicle (as known in the art of battery swapping). The high length to width ratio further supports solar photovoltaic panel farm (with rows-oriented perpendicular to first co-location facility) such that the electrical busbar servicing the data center also functions as the power busbar for the solar farm. As such the total electrical caring capacity is at least 10 percent less (preferably at least 20 percent and specifically preferred at least 50 percent) than the aggregate of peak operations of the solar farm plus the peak operations of the data center. This is due to the solar farm always being in energy production mode while the data center is always in energy consumption mode.

The co-location facility being a biomass growing facility (or any source of biomass) with the data center further provides an inventive utilization of a dual electrolyzer electrochemical system to produce hydrogen (including when utilized in on-site power generation system) as waste heat from the high-side pressure of regenerative thermodynamic cycle decreases the input energy requirements for hydrogen production by at least 2 percent (preferably at least 5 percent, particularly preferred at least 10 percent, and specifically preferred at least 25 percent). The dual electrolyzer electrochemical system yields carbon dioxide exhaust source that is utilized to enhance the biomass growing production rate that now doesn't require any exhaust carbon dioxide concentration increasing the effective carbon dioxide storage capacity (by at least 20 percent, preferably by at least 40 percent, and particularly preferred by at least 60 percent) within the radiative cooling system integral storage on the non-solar-facing side. The availability of the on-site carbon dioxide exhaust source provides additional fire safety to the data center. The dual electrolyzer electrochemical system carbon dioxide exhaust source is void of any combustion products enabling the CO2 to be food grade for biomass growing facility (or for any other as known in the art utilization of CO2 such as soda beverages). The particular use case of a decentralized data center expands the feasibility (and reduces logistics cost) of CO2 utilization in other co-located facilities particularly those facilities serving carbonated beverages. It is understood that the integration of a dual electrolyzer electrochemical system with a co-located biomass growing facility has the same fundamental inventive feature for virtually any regenerative thermodynamic cycle, even when the thermal energy is from a heat source different than the immersion cooling system of the data center. The CO2 as known in the art can additionally be utilized within a micro-algae biomass growing facility, in which case the CO2 is preferably stored in a liquid carbonate form, whereas the CO2 within a airborne plant is preferably stored in a gaseous form.

A feature of the invention is to realize for the thermal integration to realize a high energy efficiency and high utilization asset system throughout the entire year, notably that both heating and cooling are required respectively during the summer and winter operations (though a traditional system would have either heating or cooling not required respectively during the summer and winter operations. One exemplary of freeze crystallization system can be used independent of season for residual concentration within the aqueous phase of any biomass processing, or waste/brackish water treatment facility. One other exemplary of higher exergy heat source is pretreatment of a wide range of biomass processing, preheating of high-viscosity fuels (e.g., minimally processed biocrude or non-esterified fats and oils). A further feature of the invention is multi-functional structural elements such that the thermal integration lends itself to structural integration. Another fundamental feature of the invention is the integration of a power busbar such that placement of power consumers and power producers are distributed along the power busbar to reduce the mass and cost of power busbar as compared to non-integrated power consumers and power producers. Both the structural integration and power busbar integration are best realized in a physical building (e.g., data center with biomass growing facility) that has a length to width ratio that is at least greater than 2:1.

The inventive feature optimized via utilization of feedforward modules for asset queuing system drives the placement of high cost capital equipment assets notably data centers, as well as power generation systems, and the further recognition that it should not be determined based solely on primary asset task (respectively processing of computational task and electricity generation) especially as substantial improvements of energy efficiency and greenhouse gas reductions (i.e., emissions profile) gain in deployment. As energy efficiency increases, often with all things equal, the ratio of operating costs to capital costs also decreases placing even more burden on asset amortization rate in order to realize a ROI. Furthermore, the allocation of workload, notably computational tasks within a standalone data center, fails to realize a superior ROI. Arguably once the purchase of data center asset systems and power generation systems are completed the respective capital equipment is effectively a sunk cost, and in fact for many types of equipment that has diminishing replacement costs (sometime, particularly for data center GPUs and CPUs with reference to substantially decreasing capital equipment cost on their primary metrics of cost per FLOPS and energy cost per FLOPs continue to decrease) the amortization rate should be based on equipment replacement cost per unit of performance measure as opposed to actual equipment purchase cost. Other exemplars of diminishing replacement costs within power generation systems include solar panels, battery electrical energy storage devices, and electric vehicles that by definition contain significant value of their battery electrical energy storage devices, and heat pumps.

An exemplary instance where assets are operating on emissions-free energy sources fails to realize optimal results: beginning with failure to account for embedded carbon in the production of the capital equipment assets; neglecting operational byproduct benefits that are location specific having a financial impact; failing to provide any workload prioritization between approximately equivalent operating costs or emissions profiles; failing to provide any workload prioritization between multiple asset locations within either the same electric grid or approximately equivalent electric grids (from an at least emissions profile and preferentially also an operating cost basis); failing to account for substantial reductions of energy consumption per FLOPS for performance of workload; and failing to provide sufficient incentive to a second owner or beneficiary as compared to a first owner of high cost capital equipment assets to at least compensate for the second owner's increased direct operating costs concurrently with the first owner's decreased direct operating costs.

The inventive queueing system is based on placement of computational task within a network of distributed placement of computational asset having dynamic capacity availability, preferably dynamic placement of the computation assets, and specifically dynamic byproduct revenue streams realized by performance of computational task on the respective computational asset based on at least in part on real-time conditions external of the computational asset or specifically preferred based on at least in part on future feedforward conditions external of the computational asset, preferably leveraging feedforward control loop, based on an at least in part by-product (used interchangeably with byproduct) revenue streams associated with byproducts of asset operational utilization NOT primary power production revenue. Current asset operational utilization cost, particularly for data centers, is dominated by energy costs and therefore decisions for computational task queuing is also dominated by energy cost reduction (including decisions impacting greenhouse gas reductions) of a first data center location in comparison to a second data center location. This energy cost decision matrix fails to account for byproduct revenue, cost displacement, replacement cost, and/or utilization factor impact on at least a proximity location. The further gains in computational energy density (i.e., FLOPS per kWh) makes the shortcomings of the energy cost decision matrix worse over time. This energy decision matrix fails to account for the potential of any subset (or all) of the assets to be deployed away from the first data center location (or at least serving the at least one of a proximity location from the current location) to the at least one of a proximity location.

Data centers, due to queuing being a process of moving non-physical assets, can rapidly move from the first data center location to any of a wide range of second data center locations with minimal effort and relatively nominal penalty. A first data center location that is comprised of at least one of a second data center location can maintain client performance (i.e., computational asset availability) across the network of first data center and second data center(s). One such use case is a power outage at the first data center location having either backup or primary power generation assets that simply needs to provide sufficient intermittent energy at the first data center location to transition all (or a subset) of queued computational task from the first data center location to any of the second data center location(s), as there is now a high likelihood that the backup or primary power generation assets will have more value by serving the at least one proximity location(s). In other words, a grid outage at a first data center is likely accompanied by a grid outage at a hotel, hospital, airport, etc. where the functionality at the respective proximity location doesn't have the option of seamless re-queuing of its respective operational task.

A data center is typically comprised of computational asset (e.g., servers whether CPUs or GPUs), cooling assets, thermal dissipation assets, and on-site power generation assets (i.e., typically backup power, though increasing frequency due to grid interconnect queuing delays primary power) installed in a rigid arrangement. Such a data center fails to account for primary data center revenue fluctuations (including periods of low computational asset utilization) and even more so seasonal variations that further exacerbate cooling and thermal dissipation asset utilization. This energy cost decision matrix fails to recognize that operations of cooling assets, thermal dissipation assets, and on-site power generation assets can be operated in an individual non-synchronized manner (i.e., not for the current first on-site data center) in order to maximize byproduct revenue, cost displacement, replacement cost, and/or utilization factor impact on at least a proximity location beyond the otherwise cost-differential of the first data center location as compared to at least one second data center location. Another typical, and increasing, use case is the byproduct production of waste heat at the data center which in almost all instances has no value within the current first data center location.

The increasing utilization of liquid or immersion cooling, particularly by my previous inventive configurations with heat pumps and preferably regenerative heat pumps, empowers a higher quality heat source (i.e., exergy) now more suitable for utilization at an at least one proximity location(s). Adjusting computational task queuing independent of primary power operational costs enhances the revenue opportunities of the network assets beyond the benefits of operational cost savings, which can be adjusted on a time-of-day, seasonal, or intermittent basis due to externalities (i.e., factors that impact at least one proximity location with at least a greater revenue impact on the at least one proximity location as compared to the current first data center location including any performance penalties attributed to the queuing location change from the current first data center location as compared to any of the at least one proximity location). Yet another typical, and increasing, use case is the substantial increase in underutilized computational asset located external of the first data center location (or for that matter external of any data center location) notably autonomous vehicles and smartphones both having increasing GPU (and CPU) capacity to realize ever-increasing utilization of exemplary computational tasks such as machine learning. These underutilized computational asset become very attractive to perform computational tasks in at least one proximity location computational asset, especially as their respective computational energy density increases (i.e., the dominant computational cost becomes acquisition cost amortization which is absolutely required for its primary purpose of driving or personal utilization and thus the amortization rate for non-primary purpose can be nominal in comparison to the computational asset at a first data center location). In other words, a nominal benefit to the underutilized computational asset can entice that computational asset to be used for a secondary purpose where the benefit accrues to the user of the computational asset at the least one proximity location. This nominal benefit can range from: waste heat from the now utilization of the computational asset, discounted communication access fees, pooled access to backup power generation asset or cooling asset, to a revenue stream that at least offsets any actual incurred operating costs of the computational asset at the least one proximity location. Recognizing that data center performance metrics include communications latency and an increased likelihood of a worst latency response for the at least one proximity location as compared to the first data center location, there needs to be additional measures to reduce further increases of latency.

Furthermore, the shift of computational task from the first data center location to the at least one proximity location introduces substantial opportunities for data leakage and/or data hacking. The inventive system must prevent data leakage, data hacking, etc. such that authentication (encryption includes location of stationary receiving antennas for both sides of data transfer) especially for mobile computational asset (encryption includes location of stationary communication receiver and further relies on stationary communication receiver to mobile device authentication methods) is required. Other economic impacts can distort the decision matrix for computational task queuing location from a first location to an at least one proximity location due to other byproduct(s). One ever-increasing byproduct having value substantially greater than any cost differential for power between a first data center location and any other location is the exemplary byproduct production of carbon nanotubes or upgrading of biofuels both of which can lead to highly leveraged economic impact within the host community of the at least one proximity location.

Waste heat, as noted within the previous inventive patent application, is another economic impact though in almost all instances its financial value is less than the power operating cost, whereas the byproduct revenue in almost all instances will have value greater than the power operating cost differential between the first data center location and any other location (e.g., at least one proximity location or the at least one second data center location). The previous patent filing neglected the new inventive feature of establishing a comparative value basis between locations, especially proximity locations, such that the value must account for the otherwise displacement of heat generation required to offset the provided for waste heat. In other words, the waste heat derives its value by accounting for otherwise displacement of heat generation in terms of energy cost, any amortization cost of capital asset, any maintenance cost of capital asset, and therefore energy efficiency notably coefficient of performance such as for heat pumps.

Economic impact beyond the boundaries of the first data center (i.e., sole priority on operating economics to the owner/operator within the data center at the first data center location, or aggregate operating economics of multiple data centers by the same owner/operator at multiple second data center locations) notably within the surrounding community (i.e., different owners or stakeholders) at an at least one proximity location is becoming more critical as the ripple effects of especially large-scale data centers is creating adverse impacts on the host community including reduced excess grid capacity to support higher job creating economic opportunities (e.g., data centers have a very low job:peak power demand ratio), higher electricity costs, and significantly higher water consumption all individually and in aggregate creating true realized higher costs within the host community. There is a need for data center operations to create byproduct benefits that accrue to the host community and not solely data center owners/operator/stakeholders. The inventive dynamically distributed queuing system of computational task optimized for byproduct revenue opportunities that include host community benefits (a.k.a. QueView) has at least a real-time computational task routing system and preferably an advance scheduling of computational tasks to distribute the range of computational task between the first data center location, an at least one second data center location, and an at least one proximity location. Another feature of QueView is the computational task routing system includes computational tasks that specifically serve the host community “host community computational tasks”, along with a dynamic pricing system that encourages the queuing to take place during off-peak (i.e., excess/spare computational capacity) and more preferably host community computational tasks that are advance schedulable and/or at least having reduced latency sensitivity.

The dynamic pricing system at a minimum further differentiates between task beneficiaries within the host community “host community beneficiary task” from task beneficiaries external of the host community. Such host community computational tasks include: a) predictive energy production modeling for solar and/or wind energy systems, b) traffic control, c) weather predictions and notably predictive energy consumption for facilities in which energy consumption is a function of weather dependent conditions (e.g., heating or cooling), and d) occupancy dependent tasks within hospitals, hospitality, entertainment venues, transportation centers. These secondary capacity systems (at least relative to the primary capacity for computational asset at the first data center location) are preferably performed by computational asset having excess capacity. Other computational tasks that have reduced latency sensitivity include weather forecasting, scientific computing including structural and materials analysis, and simulation computations; high computational video and creative content creation including 3d rendering and animation; computer-aided design and engineering, fraud detection, and insurance risk modeling etc. The preferred computational task routing system utilizes a combined feedback and feedforward queuing system, in addition to dynamic placement of computational asset to maximize byproduct revenue and/or benefits to host community beneficiaries.

Further details of the invention are depicted within the exemplary figures provided. It is a fundamental feature of the asset queuing system that a marketplace of product and/or service offerings has purchase decisions being made between at least two parties (i.e., often on nominal cost differential) at very low-cost differentials with a winner take all approach. Exemplary marketplaces include Expedia travel purchase, ERCOT, PJM, NYSE, rental costs, etc. though in the aforementioned examples it is virtually impossible to create and then valorize based on operational byproducts.

Turning to FIG. 1 depicts the feedforward and feedback loop control system 130. The data center has a first partial data center electronics with a first heat source and a second partial data center electronics with a second heat source. A plurality of sensors are configured to measure a plurality of parameters relating to the first partial data center electronics and the second partial data center electronics, both having a control system that is configured to receive data from the plurality of sensors and generate a plurality of disturbance temperatures for control estimates for the first partial data center electronics and the second partial data center electronics that are based on the data from the plurality of sensors, and to determine a feedforward temperature control contribution that is at least based on disturbance temperature transfer estimates as measured temperatures within the first partial data center electronics and the second partial data center electronics. The feedforward and feedback loop control system modulates temperature setpoints for the first partial data center electronics and the second partial data center electronics. The preferred embodiment has the first heat source from an immersion cooling system in direct thermal contact with the first partial data center electronics, the second heat source is from an air cooling system in indirect thermal contact downstream of the second partial data center electronics. The particularly preferred embodiment combines the feedforward inputs (e.g., temperature sensors, meta sensors, and other plurality of sensors) as a control contribution and the feedback loop (e.g., temperature transfer contribution) to determine at least one target temperature setpoints within the first partial data center electronics and the second partial data center electronics by the immersion cooling system and the air-cooling system. The control system determines required values of cooling by the immersion cooling system and the air-cooling system to achieve the target temperature setpoints.

The specifically preferred embodiment is further comprised of at least one co-located process that is in thermal communications with the data center, whether through the immersion cooling system or the air-cooling system, with the control system establishing a thermal transfer rate by at least monitoring with through the feedforward and feedback loop control system 130 for the determination of a predicted deviation between an actual value and a required value of the determined required values of cooling by the immersion cooling system and the air-cooling system preferably at least in part based on a future required value of the co-located process thermal transfer rate, weather predictions, and variations of time of day or seasonal of at least one of the data center and co-located processes (or preferred to be both of the data center and co-located processes e.g., biomass growing facility, water treatment facility).

The feedforward and feedback loop control system 130 is the preferred embodiment of the control system for monitoring all inputs and controlling all regulated outputs including the feedforward outputs 126. In a number of embodiments, the high energy efficiency and high utilization asset system 132 preferably uses a feedforward and feedback loop control system 130 as depicted in FIG. 1. The operations may be carried out by the feedback module 112 at the minimum and preferably with the feedforward module 120 or may be embodied in different hardware. It is configured to control the setpoints 128 corresponding to the parameters within the point parameter sets and/or physical parameter sets at the respective locations pluralities of sensors within the data center, immersion cooling system, air-cooling system, and co-located processes such as biomass growing facility or water treatment facility. The real-time meta sensor 102 (or any sensor value corresponding to a parameter of the point parameter set or physical parameter set) of the high energy efficiency and high utilization asset system 132. A feedback module 112 is configured to issue a feedback command 106 when the setpoint 128 sensor, as communicated through the feedback loop 110, moves from a setpoint 128 to produce a feedback error 108 (setpoint 128—any sensor value corresponding to a parameter of the point parameter set or physical parameter set). Accordingly, the feedback module 112 only begins to respond after the any sensor value corresponding to a parameter of the point parameter set that has deviated from the setpoint 128 and by the feedback error 108.

A feedforward module 120 is included to monitor any sensor value corresponding to a parameter of the point parameter set by establishing a meta sensor 210 in the high energy efficiency and high utilization asset system 132, which is used to predict an impact on a wide range of point parameter set and physical parameter set with particular monitoring of any sensor within the plurality of sensors value corresponding to a parameter of the point parameter set, before at least one of the real-time parameters of any of the point parameter set and physical parameter set is able to determine a resulting deviation. The feedforward module 120 receives feedforward inputs 116, such as from any sensor (or meta sensor 102) value corresponding to a parameter of the point parameter set and physical parameter set. Based on the computed generated meta sensor 102, the feedforward module 120 issues a feedforward command 114 that alone or in addition to the feedback command 106 from the feedback module 112 determines a commanded feedforward modified command 118 to the high energy efficiency and high utilization asset system 132 and achieves optimal energy efficiency and faster ROI through high asset utilization. The feedforward and feedback loop control system 130 uses both the feedback comparator 122 and the feedforward comparator 124 respectively for the feedback loop 110 and feedforward control system 104.

The feedforward and feedback loop control system 130 further includes energy storage device for at least one of cooling from downstream of expansion component of the mechanical vapor recompression system or heat pump system and heating from downstream of compressor of the mechanical vapor recompression system or heat pump system, and preferred embodiment the further storage of carbon dioxide exhaust source that decouples carbon dioxide production from subsequent consumption within the biomass growing facility during daylight plant growth (concurrent with higher levels of plant transpiration, preferably as a function of time for plant transpiration, and particularly preferred as a further function of time of the air-cooling system within the data center and its plurality of sensors including relative humidity and temperature). The feedforward and feedback loop control system further includes a variable airflow by the air-moving device in addition to airflow direction across the width of the data center.

An additional feature, beyond the original filing, of the invention is a particularly preferred feedforward control system for any pooled asset (that being any asset at a current first location typically originating of the asset owner, in which the individual pooled asset can be transported to a second location typically within the available proximity locations or which computational tasks beneficiary to a third party not being the asset owner are performed at any location whether it be a first location, a second location or any proximity location) though notably data center asset placement and power generation asset placement and electrical energy storage asset and thermal energy storage asset based is a function of on aggregate cost differential of a) logistics costs for placement of assets from first to second location, b) loss of revenue during logistics transit time plus reconnection time of assets, c) gain in revenue associated with waste heat utilization (revenue is adjusted for coefficient of performance “COP” as known in the art of alternative of on-site energy recovery/temperature lift when a requirement to purchase waste heat) thus this needs to account for alternative thermal energy sources such as on-site solar thermal or already on-site process thermal recovery or already on-site power generation asset waste heat. All things equal the displacement value of waste heat displacing thermal energy from an electric heat pump having a COP greater than 1 is of less value than thermal energy from a electric resistive heating element.

Another embodiment of the asset queuing system is utilization queuing of any asset, notably assets in which at least one of technology gains or manufacturing scale increase gains lead to annual (or anticipated time in which hours of operation reaches projected lifetime hours of operation) reduction of replacement cost decreases of at least 1 percent, preferably at least 2 percent, and specifically preferred at least 5 percent per annum, is a function of an amortization adjustment rate that includes a multiplication factor for projected per hour replacement cost decrease relative to the standard amortization rate for asset projected lifetime (i.e., if asset projected lifetime is 10000 hours and over that same period of time the cumulative replacement cost decreases 80 percent) thus exemplary amortization adjustment rate is amortization value per unit of operation X (1-0.8). This embodiment more accurately reflects that each hour of operation cost basis for the asset has negligible real acquisition price basis (though accountants calculate ROI based on acquisition price) but rather the cost to replace the availability of an approximately equivalent asset such that the perishable capacity is replaced within the pooled assets to maintain an approximately equivalent operation capacity.

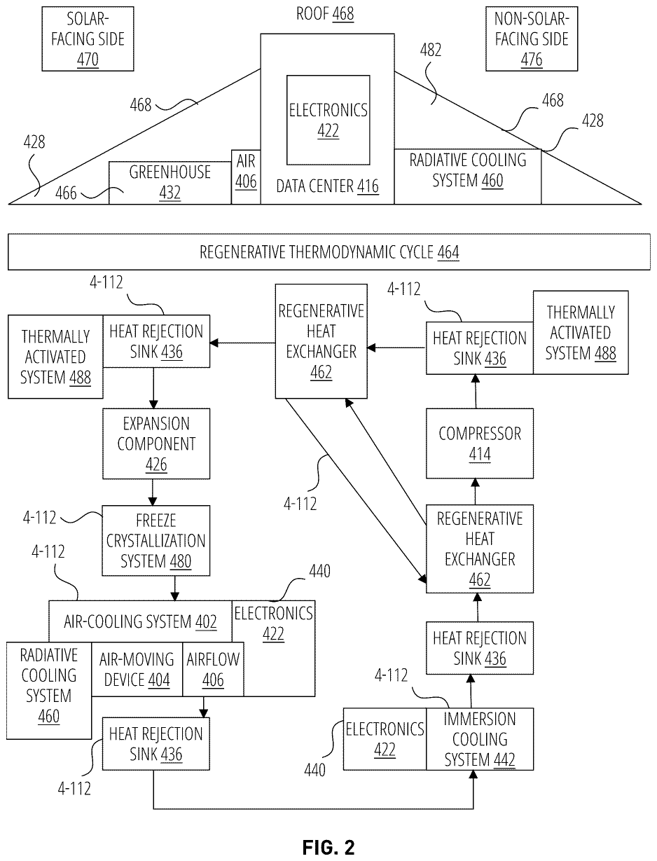

Turning to FIG. 2 depicts structural advantages within the interior of the co-location facilities. The structural costs of a data center are small in comparison to the computational, electrical, mechanical and power generation costs, however when configured in the inventive layout it substantially reduces the structural costs for co-located multifunctional facilities (e.g., notably greenhouse or other biomass growing facility). Inherent data center structural elements require only incremental costs such that the data center can also operate more efficiently by leveraging the structure into additional non-solar-facing side and solar-facing side functions not inherently integrated into data center operations. The structural elements at the peak height of the data center provides structural cable anchor points, as it is known that structural cable is a highly efficient (i.e., cost and mass) structure especially for sloped structures as preferred for the non-solar-facing side and solar-facing side. The sloped structures also realized benefit to the data center by reducing the wind loading on what otherwise would be 90-degree walls isolating the data center from the environment. The sloped structures reduce snow and ice dead loads, particularly when the sloped structures have icephobic coatings (preferably bi-layer or air-layer structures in which snow and ice inherently slide off the structure by way of crack propagation). The cable orientation to maximize crack propagation is in a vertical orientation as compared to a horizontal orientation, with the particularly preferred cable structure having a top-facing foam layer to further minimize ice strength adhesion to the then film layer isolating the non-solar-facing side and solar-facing side operations from the environment. In addition to the sloped cable structure, sloped ducting also preferentially serves as structural support to the film layer and to the perimeter structural elements of the data center.

A preferred embodiment of the perimeter structural elements and/or columnar supports of the data center inherently provides lower structural cost for water storage, energy storage devices, frozen clean water source storage, etc. The non-solar-facing side and solar-facing side structure enhances the environmental isolation of the otherwise perimeter structural elements of the data center. Furthermore, the sloped film layer is an effective air distribution method for conservation of momentum from air-moving device within the air-cooling system into the solar-facing side in particular. In this manner, the solar-facing side benefits from reduced energy consumption as compared to otherwise needing to both pay for additional air-moving devices and their respective energy operating costs. This configuration is particularly relevant for adjoining solar-facing side (as a biomass growing facility) with the data center due to the relatively high airflow velocity required to eliminate hot spots within the data center asset system.

The now created shading resulting from the height of the data center prevents the non-solar-facing side from “seeing” the sun. This non-solar-facing side however is still sky-facing and is therefore ideal for radiative cooling system, which realizes the same structural benefits as the solar-facing side. Therefore, the radiative cooling system is able to operate as a sub-atmospheric cooling system by benefiting from the same environmental isolation (as realized in the solar-facing side) also using the sloped film layer. Radiative cooling system operating in a sub-atmospheric cooling mode to realize virtually year-round benefits requires the inventive co-location facility of the at least two processes with the inventive thermal isolation of high-side pressure benefit for one of the at least two processes and the low-side pressure benefit for at least one different second process. In order to realize the benefit of sub-atmospheric cooling the radiative cooling system must be environmentally isolated from the atmosphere, which then by definition utilizes dynamic feedforward command of operating conditions at least within the data center (i.e., first process). Floating the operating temperature of the air-cooling system predominantly has benefit on the second process and not on the first process. And maintaining the radiative cooling system within an environmentally isolated from atmosphere by definition requires at least a film layer. Therefore, the further inventive utilization of structural sloped cable reduces the incremental cost of environmental isolation of the radiative cooling system, and the co-existence of the second process increases the variation of time of day or seasonal benefit to realize faster ROI.

Another critical aspect of the inventive structure is such that perimeter structural elements serve both the first and second of the co-located processes. Putting water into the interior of a structural element (e.g., pipe) intentionally on the perimeter of the first process (e.g., data center) and the second process (e.g., biomass growing facility) when the perimeter is not environmentally isolated from the atmosphere is simply “asking” for trouble in terms of frozen pipes. However, the year-round operations of a data center ensure the availability of waste heat to prevent frozen pipes and therefore leveraging the horizontally oriented structural elements to provide both first process structural benefit as well as fluid flow (i.e., eliminating the otherwise separate horizontal structure element and fluid piping). Furthermore, since much of the horizontally oriented structural elements have excess structural capacity (design case is for high wind, snow or ice loads) these same horizontally oriented structural elements in combination with a feedforward command enable the horizontally oriented structural elements (except during the aforementioned high wind, snow, or ice loading periods of time) to also serve as structural elements for secondary processes (e.g., planting, seeding, watering, or harvesting of plants). The particularly preferred horizontal structural elements are polymers such that limited if any corrosion takes place. This is particularly important for structures that have a greater than 10:1 length to width ratio.

In the embodiment where the first of the at least two co-located processes being a data center, the inventive data center has two thermally isolated electronics. The preferred embodiment has the first partial data center electronics being the microprocessors providing the computational capabilities (e.g., Nvidia processors for machine learning) in thermal communication with the immersion cooling system (i.e., first heat source being a first heat rejection sink having a first heat rejection temperature), and the second partial data center electronics being the other equipment (as known in the art, such as communications and networking equipment) in thermal communication with the air-cooling system (i.e., second heat source being a second heat rejection sink having a second heat rejection temperature). The first heat rejection temperature is at least 10 degrees Celsius higher than the second heat rejection temperature. The second heat source also has relative humidity sensor(s) in addition to its temperature sensor(s), in which relative humidity is important to monitor as in the data center to ensure moisture condensation doesn't take place on the electronics, and at least to limit mold growth within the biomass growing facility. A preferred relative humidity method of control is a desiccant dehumidifier (particularly preferred as a liquid desiccant dehumidifier with a desiccant regenerator), again now the circulation of liquid desiccant can also be within horizontally oriented structural elements. The power busbar, as noted earlier, is preferably utilized as a structural element and not solely as an electrical element. Particularly preferred the power busbar serves both power consumers (data center, greenhouse lighting including light emitting diodes “LEDs”, air-moving devices within the air-cooling system, etc.) as well as power producers (e.g., power generation system, solar panels from within the solar-facing side). The greater than 10:1 ratio of length to width makes the sharing of the power busbar particularly cost advantageous such that the concurrent power generation system providing power (i.e., current) effectively reduces the distance (and therefore the aggregate current) to power consumers.

The top figure of FIG. 2 depicts the side view of the co-location facilities having a solar-facing side 470 and a non-solar-facing side 476 in this preferred embodiment having two fresh air intakes 428 (one on the lower portion of the greenhouse 432 side, solar-facing side 470; and the second in thermal communications with the radiative cooling system 460 (it is understood that the radiative cooling system 460 can interact indirectly with the air-cooling system 402 (as shown in the lower figure also within FIG. 2) via a heat transfer fluid as known in the art. The airflow 406, which flows due to a pressure differential created by an air-moving device as known in the art, is capable of switching flow directions between the at least one fresh air intake being upstream of the biomass growing facility (i.e., greenhouse 432), upstream of the radiative cooling system 460, or upstream of the electronics 422 within the data center 416. In the particularly preferred embodiment during winter operations the airflow 406 begins in the fresh air intake 428 on the non-solar-facing side 476, is in thermal communications with the radiative cooling system 460, then continues to pass via the air-cooling system 402 removing heat from the electronics 422 (predominantly the non-microprocessor portion) within the data center 416, and then finally into the greenhouse 432. The particularly preferred embodiment (though not shown in this figure) also incorporates carbon dioxide exhaust sources 412 from within the integral gaseous storage 482 (also not shown in this figure). The structural layout is also important as also depicted in this side view (top portion of FIG. 2) with the preferred embodiment (though particularly preferred utilizing structural cable 302 (not shown in this figure, but immediately below the as shown roof 468 segments). The specifically preferred embodiment has a continuous structural cable 302 that begins on the non-solar-facing side 476 ground mounted area all the way to the solar-facing side 470 ground mounted area, including physical communications to all the roof 468 segments.

The bottom figure of FIG. 2 clearly depicts the overall regenerative thermodynamic cycle 464 in which the electronics 422 from within the data center 416 is partitioned between the immersion cooling system 442 for the predominantly microprocessor portion, and the air-cooling system 402 for the predominantly non-microprocessor portion. In this manner the higher operating temperatures 472 in the immersion cooling system 442 are predominantly thermally isolated from the lower operating temperatures 472 in the air-cooling system 402. Beginning in the bottom left portion of this thermal communications flow depiction heat is removed from the immersion cooling system 442 (as known in the art) through a heat transfer fluid (directly via regenerative thermodynamic cycle 464 working fluid or indirectly). An optional heat rejection sink 436 has the ability to either regulate heat transfer fluid flow rate and/or at least partial bypass utilizing a feedforward command 114 (also as shown in FIG. 1, and throughout this FIG. 2 where actuators 4-112 or as known in the art regulators are provided), and further understood implicitly that feedforward commands 114 can be used to regulate any or all actuators 4-112 within the regenerative thermodynamic cycle 464. The heat transfer fluid then continues into the regenerative heat exchanger 462 (such that excess heat from the high-pressure side of the cycle is reused as a preheat upstream of the heat transfer fluid flowing into the compressor 414 (where heat of compression increases the temperature 472 of the heat transfer fluid). This now peak operating temperature is in thermal communications with any thermally activated system 488 (notably a biomass processing facility that performs as known in the art at least partial liquefaction, or water treatment facility 484, though not shown, etc.) prior to continuing into the regenerative heat exchanger 462 (to transfer excess thermal energy from the high-pressure side to the low-pressure side in order to maximize the high-pressure side temperature 472 provided to the thermally activated system 488. Downstream of the expansion component 426 is an optional (and preferred) phase change cooling component (as shown a dual-purpose freeze crystallization system 480 that both creates a frozen clean water source 430 (though not shown) and enables decoupling of cooling when the frozen clean water source 430 thaws outside of the water treatment facility 484. The heat transfer fluid now enters the air-cooling system 402 to provide heat removal from the predominantly non-microprocessor portion of the electronics 422 (and as shown with pre-cooling of the airflow 406 utilizing the radiative cooling system 460 upstream or downstream of the air-moving device 404, but always upstream of the electronics 422). As noted elsewhere the direction of airflow 406 can switch, whether that be by rotating the air-moving device 404 at least approximately 180 degrees thereby switching from “pushing” the air through the electronics 422 to “pulling” the air through the electronics 422 (or vice versa). Another optional heat rejection sink 436 is in thermal communications with the heat transfer fluid when any excess cooling remains. And now the regenerative thermodynamic cycle 464 is completed as it returns back to the immersion cooling system 442.

Additionally, and importantly the regenerative heat exchanger 462 reduces the temperature 472 of the heat transfer fluid upstream of the expansion component 426 (and preferably further upstream of an optional heat rejection sink 436 also in thermal communications with a lower than previous thermally activated system 488, or simply a condenser as known in the art). A preferred expansion component 426 is an expander (as known in the art to both extract mechanical energy and to realize a lower temperature 472) and not solely an expansion valve (also as known in the art). Though not shown in this figure, it is understood that the cooling as provided by the radiative cooling system 460 can be in direct thermal communications to the greenhouse 432, the immersion cooling system 442 or the air-cooling system 402. A fundamental feature is that the airflow 406 flows across the width of the data center 416 (as shown in the top figure of this FIG. 2) for aforementioned purposes, notably reducing energy aggregate power consumption 4-114 as required to drive the air-moving devices 404. The regenerative thermodynamic cycle 464, whether it be operating as a mechanical vapor recompression system 444 or heat pump 434 system has a rejection temperature at least 10 degrees Celsius (high-pressure side) higher than the immersion cooling system 442 discharge temperature 472 and most importantly at least 10 degrees Celsius higher than when the first portion of the electronics 422 is not thermally isolated from the second portion of the electronics 422. Though not explicitly shown, the desiccant regenerator 418 can be in thermal communications with any of the heat rejection sinks 436 on the high-pressure side of the regenerative thermodynamic cycle 464 as a preferred method to regulate relative humidity 466 within the greenhouse 432.

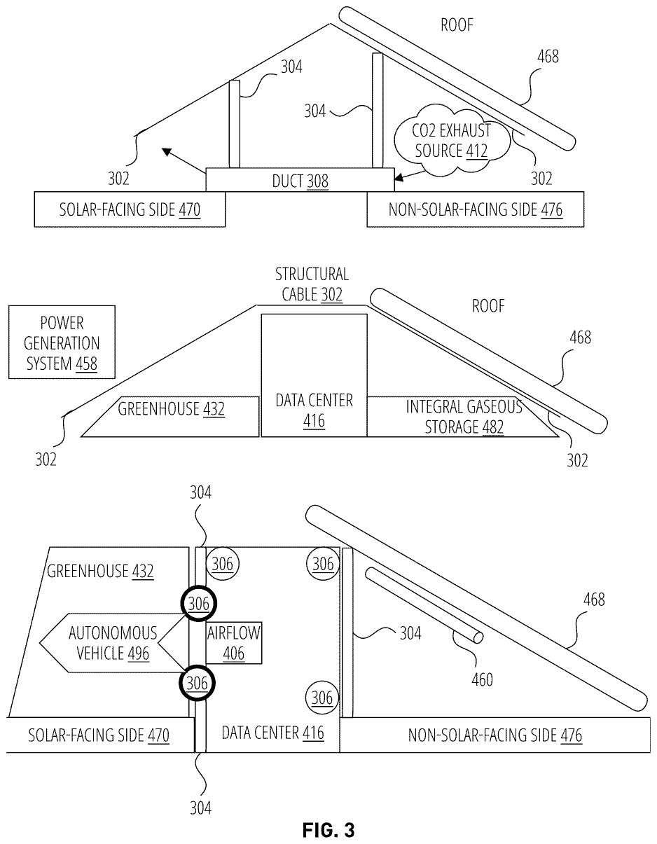

Turning to FIG. 3 depicts structural advantages external (but adjoining) of the co-location facilities. The solar-facing side of the structure is also anticipated to contain environmentally isolated solar panels (either or both solar photovoltaic or solar thermal) that provides at least the following advantages: a) solar panels at least 5 percent (preferably at least 15 percent, particularly preferred at least 30 percent, and specifically preferred at least 50 percent) lighter than non-environmentally isolated panels as the individual solar panels do not need to accommodate snow, wind, ice, or hail conditions, b) solar panels with enhanced thermal isolation again due to environmentally isolated solar panels to enable active heat rejection sink (increasing solar to electric efficiency as known in the art) with waste heat recovery, and c) uninterrupted noise isolation by continuous film isolating the solar panels from the environmental conditions (i.e., continuous film has superior sound reflection as compared to discrete solar panels). The continuous film also provides superior wind channeling such that reduced energy consumption is required by the air-moving device of the air-cooling system when atmospheric air has a temperature less than air-cooling system temperature requirement (also known as fresh air intake or free cooling) by at least 5 percent (preferably at least 15 percent, particularly preferred at least 30 percent, and specifically preferred at least 50 percent) in fan energy consumption of the air-moving device.

Many of the same benefits are realized on the non-solar-facing side but in this instance as directly replacing the radiative cooling system for the aforementioned solar panels. Thermally isolated radiative cooling system from atmospheric conditions increases the operating envelope in which free cooling is realizable therefore reducing energy consumption of the air-cooling system by at least 5 percent (preferably at least 15 percent, particularly preferred at least 30 percent, and specifically preferred at least 50 percent) in cooling energy consumption of the air-cooling system.

Yet another inventive feature of the co-location facility is the integration of a landing strip for aircraft (e.g., air taxis, vertical takeoff drones, etc.). It is particularly advantageous that either of the non-solar-facing side or solar-facing side of the structure provides at least one of sound-shield for the aircraft to virtually any adjoining physical space. The slope of the co-location facility also shields light pollution to virtually any adjoining physical space, such that the lighting providing enhanced safety for the aircraft especially during aircraft landing operations. It is understood that the aircraft can land at ground level within the adjoining physical space of the non-solar-facing side or solar-facing side, or at a raised altitude on top of the non-sloped space between the non-solar-facing side and solar-facing side such that the physical space below the raised landing area is no longer “wasted”. These inventive features are particularly realized when the length to width ratio of the co-location facility is greater than 10:1, and of special significance for decentralized distributed systems within multi-use campuses (e.g., sustainable community). The multi-functionality of the co-location facility within a multi-use campus further enables above ground (though secure) fiber communications within any of the environmentally isolated physical space. And the raised portion of the co-location facility further enables direct line of sight optical communications (enhancing privacy, cybersecurity, etc.) by avoiding ground visual obstructions and enhancing system performance for community-based communications enabling superior tele-commuting, tele-health, education, and even entertainment functions.

Another embodiment of the co-location facility having both a length to width ratio greater than 10:1 and a continuous film for environmental isolation is the ability of the co-location facility to also isolate the movement of autonomous vehicles from people within close proximity providing enhanced safety operations especially during autonomous operations of the autonomous vehicles. It is understood that the autonomous vehicle transport can be within the co-location facility or external to the co-location facility each having their respective distinct advantages. Both have the fundamental advantage of providing a significant traveling distance within the multi-use campus such that the autonomous vehicles are predominantly isolated from people during autonomous operations such that the autonomous vehicle can be derated for levels of autonomous within this highly curated and people-isolated physical space (e.g., from Level 5 to Level 4 or even Level 3). Operating within the co-location facility provides superior isolation from everything external of the co-location facility (though with the introduction of air infiltration into the controlled conditioned spaces) including environmental isolation for the autonomous vehicles as well (at least while within the co-location facility). Operating external of the co-location facility does provide a continuous isolation (though less secure) barrier for the autonomous vehicles and a highly curated physical space reducing the viable areas relative to the autonomous vehicles that can create safety challenges.

This figure FIG. 2 has three sub-figures (referred to as top, middle, and bottom). The top and middle figures depict side views with the top figure without a flat roof 468 section (as shown in the middle figure), though for clarity only the structural cables 302. It is understood, as shown in the bottom figure but again for clarity only on the non-solar-facing side 476 that the roof 468 segments are supported (and above) the structural cables 302. Beginning from the top right portion of the top figure on the non-solar-facing side 476, the roof 468 (is preferably a transparent film 304, though not explicitly shown) is supported by a vertically oriented structural cable 302 and further envelopes the radiative cooling system 460 (not shown in this figure) to provide sub-atmospheric cooling (below the atmospheric temperature 472 as known in the art). The carbon dioxide exhaust source 412 is transferred through a duct 308 into the solar-facing side 470 (i.e., greenhouse 432), as shown below the respective space but understood to be preferably closer to the roof 468 (shown as is for clarity). Furthermore, additional vertically oriented films 304 are shown (in which case not necessary to be transparent or translucent) to isolate the environmental conditions as regulated by the environmental system 424 (not shown) for individual control (also preferably via feedforward and feedback loop control system 130) particularly between the solar-facing side 470 and the data center 416. The films 304 notably isolate both the temperature 472 and relative humidity 466 such that the relative humidity of the data center 416 is lower by at least 5 percent than the greenhouse 432 relative humidity. Continuing to the middle figure, the only fundamental difference is the top figure has an “A” shape roof while the middle figure has a flat top above the data center 416 (serving as aforementioned landing area for drones or air taxis). The non-solar-facing side 476 area below the roof 468 stores carbon dioxide exhaust source 412 within an integral gaseous storage 482, though in this middle figure the ducting is not shown. Adjoining power generation systems 458 are preferably perpendicular to the length of the co-location facility 4-104, particularly when this includes solar panels to further enhance the on-site power energy production capacity while also leveraging the existing power busbar capacity that is within (though not shown) in at least one of the horizontal structures 306.

Finally, onto the bottom figure, the non-solar-facing side 476 shows the integral radiative cooling system 460 underneath the roof 468 (that is supported though not shown by vertically oriented structural cable 302) again having a film 304 to environmentally isolate from the adjoining data center 416. Five instances of horizontal structures 306 are depicted with the two on the furthest left being multifunctional to support a preferable autonomous vehicle 496 (that performs various as known in the art agricultural functions within the biomass growing facility 408 (i.e., preferably a greenhouse 432), such that this layout enables structural elements to be multifunctional in both the data center 416 and greenhouse 432 with a particularly preferred embodiment such that these horizontal structures 306 can provide support and/or containment of water serving both fire safety in the data center 416 and greenhouse 432 (or containment of heat transfer fluid, or even containment of a power busbar). As shown, these two horizontal structures 306 do not block airflow 406 between the greenhouse 432 and data center 416 (and particularly preferred provide support for the air-moving devices 404 (though not shown, including the ability to rotate on a horizontal axis to switch the direction of airflows). Each of the other horizontal structures 306 (as shown, though not necessarily needing to be in the representative position) are also preferably multi-functional while also serving as providing dead load support of films 304, structural cables 302, and roof 468 segments.

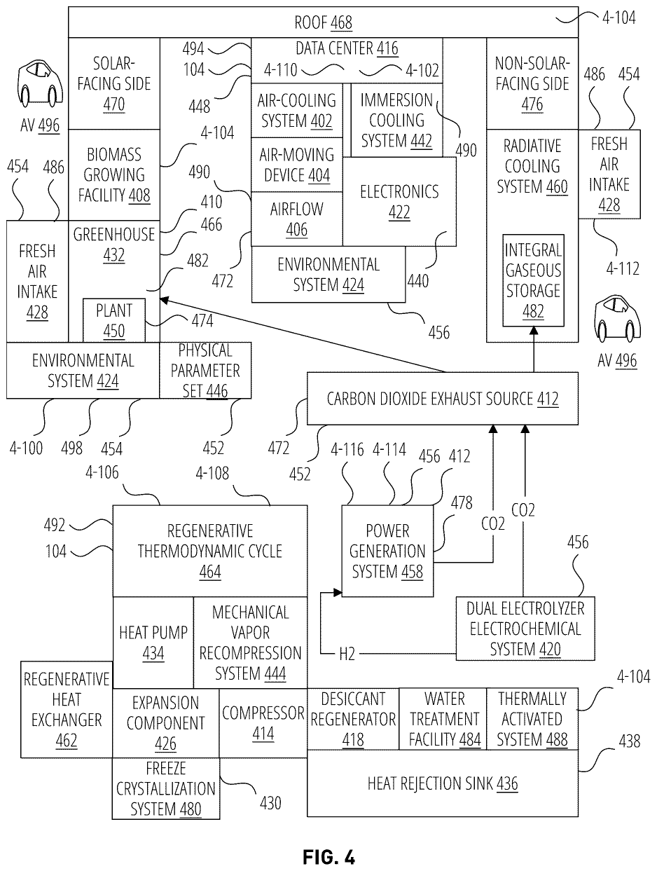

Turning to FIG. 4 depicts integral storage advantages within the interior of the co-location facilities. As noted in FIG. 3, the co-location facility within a multi-use campus that inherently supports autonomous vehicle operations provides for external access to the integral direct current microgrid architecture via as known in the art docking methods. In this manner mobile on-site power generation assets can readily be moved, yet taking advantage of the inherent thermal, storage, and waste heat utilization assets. Power generation systems, particularly those that produce carbon dioxide exhaust sources, leverage the integral carbon dioxide storage within the non-solar-facing side (below the film barrier isolating the co-location facility from the atmospheric environmental conditions). The non-solar-facing side integral carbon dioxide storage is also preferably utilized to store carbon dioxide exhaust source (though not as a result of combustion) from the dual electrolyzer electrochemical system while concurrently producing hydrogen (preferably used immediately for on-site power generation system). The particularly preferred embodiment utilizes liquified biomass (i.e., resulting from biomass liquefaction processes as known in the art) hereinafter referred to as bio-crude (i.e., minimally processed liquid biomass) within a mixed-fuel (also as known in the art) combustion system where the feedforward and feedback loop control system 130 determines the ratio of bio-crude being directly combusted in the mixed-fuel combustor of the power generation system (i.e., mechanical) or indirectly where the hydrogen is combusted in either the mixed-fuel combustor of the power generation system (i.e., mechanical) or fuel cell (i.e., solid-state) power generation system. The feedforward command is at least a function of the available capacity of carbon dioxide storage within the interior of the non-solar-facing side (or additionally within the solar-facing side, which when it houses a greenhouse or other biomass growing facility has more stringent carbon dioxide concentration restrictions). The feedforward and feedback loop control system 130 of FIG. 1 has feedforward inputs that include carbon dioxide consumption rates as a function variation of time of day or seasonal for the biomass growing facility, further accounting for storage within the non-solar-facing side. It is recognized that multiple configurations of solar-facing side are anticipated, such that any ratio of solar-facing side having solar panels to solar-facing side having biomass growing facility can occur where the solar panel configured solar-facing side has integral carbon dioxide storage capacity just like the non-solar-facing side (with the preferred radiative cooling system). It is further understood, as known in the art, that carbon dioxide can be stored in an aqueous carbonate form (or even other form preferably via electrochemical transformation such as formic acid) whether it be a temporary carbon dioxide form for subsequent gaseous consumption in biomass growing facility or remaining in aqueous form such as consumption by micro-or macro-algae.

A key and inventive feature of this co-location facility is the recovery of pure water vapor via transpiration within the biomass growing facility for the hydrogen production (including any electrolyzer, or the preferred dual electrolyzer electrochemical system) to be subsequently and preferably utilized by the power generation system. This FIG. 4 also depicts the additional interior co-location facility benefits of the data center with the biomass growing facility, as air movement within plant growing environments (as known in the art) produces superior plants. The high airflow velocity required to eliminate hot spots within the data center is typically wasted (i.e., excess air-moving device energy consumption) though now through conservation of momentum and the adjacency of the data center with the biomass growing facility an the width of the co-location facility provides airflow benefits to the biomass growing facility preferably without requiring additional air-moving devices (and their respective energy consumption) to minimize incremental energy consumption within the biomass growing facility (i.e., adjacent functionalities reduces air-moving device energy consumption for biomass growing facility by at least 10 percent (preferably at least 25 percent, and particularly preferred at least 50 percent, and specifically preferred at least 90 percent) as compared to two distinct individual air-moving devices for the data center and the biomass growing facility. The feedforward and feedback loop control system 130 of FIG. 1 determines the airflow velocity as a function of variation of time of day or seasonal for both biomass growing facility as well as based on outdoor atmospheric environmental conditions especially when free cooling is utilized from fresh air intake. The direction of airflow varies from the biomass growing facility to the data center particularly during night time operations (i.e., when greenhouse temperature is lower than data center input temperature requirements), or vice versa being from the data center to the biomass growing facility particularly during day time operations (i.e., when data center output temperature is lower higher than biomass growing facility input requirements such as day time winter operations). When the airflow comes from the biomass growing facility to the data center it advantageously has a higher relative humidity which incrementally increases the thermal capacity of airflow supporting a reduced energy consumption of the air-moving devices by at least 2 percent of the energy otherwise required to achieve an approximately heat transfer rate within the air-cooling system of the data center. The air-moving device switches the airflow direction further as a function of the plants transpiration rate within the biomass growing facility, along with the aforementioned switching as a function of the biomass growing temperature within the biomass growing facility.

This FIG. 4 depicts an approximately physical communications between the various critical components on the top figure portion. The roof 468 is comprised of a single continuous transparent film 304 over the co-location facility 4-104. The solar-facing side 470 has a biomass growing facility 408 (preferably a greenhouse 432) further comprised of plants 450 such that this area is controlled by an environmental system 424 (having plurality of sensors 454, fixed schedule database 498, and feedback schedule database 4-100) comprised of a physical parameter set 446 (including a plurality of parameters 452, as shown for environmental system 424 but understood to be applicable for each major system). The plants 450 experience transpiration 474. The greenhouse 432 has a biomass growing temperature 410, a relative humidity 466, and inherently becomes an integral gaseous storage 482 (more restricted than the integral gaseous storage on the non-solar-facing side 476 due to physical carbon dioxide constraints of the plants 450 (and any human operators present in the greenhouse 432) such that carbon dioxide exhaust source 412 can be transported to the greenhouse 432 to optimize plant 450 growth. A fresh air intake 428 is comprised of plurality of sensors 454 and has variation of time of day or seasonal 486 (including predictive capability as known in the art) all to be used as an input for the feedforward and feedback loop control system 130. As noted earlier, an autonomous vehicle 496 (can be on either side of the solar-facing side 470 or non-solar-facing side 476) leverages the co-location facility 4-104 specifically comprised of the sloped roof 468 for safety and noise abatement purposes, of particular importance within a sustainable community. The co-location facility 4-104 as depicted has a data center 416 comprised of an air-cooling system 402 and an immersion cooling system 442 (having thermal energy quality 490 that is higher than thermal energy quality 490 of the air-cooling system 402) both serving as thermal management for heat rejection sinks 436 into the other functions either under a common roof 468 or adjoining on the perimeter. The data center 416 is comprised of a feedforward schedule database 494, feedforward control system 104, meta sensors 448, an aggregate of data center asset system 4-110, and feedforward computational task 4-102. The feedforward schedule database 494 enables the feedforward and feedback loop control system 130 to optimize system performance, in addition to the feedforward computational tasks 4-102 that have the ability to be proactively scheduled. The air-cooling system 402 is comprised of an air-moving device 404 having an airflow 406 (with physical parameter sets 446 including temperature 472) all being controlled by the environmental system 424 (further having a point parameter set 456). The air-moving device 404 is predominantly serving to remove heat from the electronics 422 (having a plethora of individual heat sources 440 predominantly being non-microprocessor portion of the data center 416). The non-solar-facing side 476 has an integral radiative cooling system 460 such that below it has an integral gaseous storage 482 for the temporary storage of carbon dioxide exhaust sources 412. The optimal system has a second fresh air intake 428 (having actuators 4-112 that regulate between an open/close position, also for the solar-facing side 470 fresh air intake 428 though not shown).

And further this FIG. 4 depicts an approximately hierarchical layout between the various regenerative thermodynamic cycle 464 system on the bottom figure portion. The preferred embodiment of the feedforward and feedback loop control system 130 utilizes the variation of time of day or seasonal 486 of the plants 450 directly impacted by their transpiration 474 rates as a function of time, in addition to the predicted fresh air intake 428 physical parameter set 446 and the variations of time of day or seasonal of operating loads of all the co-location facility 4-104 operations (e.g., greenhouse 432, data center 416, any thermally activated system 488, etc.). Multiple across operating functions within the co-location facility 4-104 components are thermally integrated through the inventive integration of the regenerative thermodynamic cycle 464, and preferably integrated both electrically and thermally with a power generation system 458. The regenerative thermodynamic cycle 464 has at least one control system 492 (preferably a feedforward and feedback loop control system 130 or a feedforward control system 104), and optimally also a statistical probability projected database 4-106 and prioritization response system 4-108 such that any feedforward computational tasks 4-102 are further optimized taking into account variations of time of day or seasonal 486 across multiple thermally and electrically integrated components in communications with the regenerative thermodynamic cycle 464. As noted also in FIG. 2 with more details, the regenerative thermodynamic cycle 464 has at least one of the heat pump 434 systems or mechanical vapor recompression system 444 respectively comprised of at least a regenerative heat exchanger 462 such that the multifunctional components within the co-location facility 4-104 provides both higher exergy heat sources and lower exergy cooling into the thermally partitioned data center 416. Minimum set of components include a compressor 414, an expansion component 426 such that the cooling portion of the regenerative thermodynamic cycle 464 preferably serves a freeze crystallization system 480 in addition to the air-cooling system 402, while the heating portion serves a wide range of thermally activated systems 488 including desiccant regenerator 418, water treatment facility 484, etc. through a series of heat rejection sinks 436 (each having a heat rejection temperature 438). Another preferred embodiment has a dual electrolyzer electrochemical system 420 (having a point parameter set 456) that consumes organic matter (not shown, but known in the art) to enable net energy production to take place even when hydrogen is generated (that as shown is consumed by the power generation system 458 that also produces carbon dioxide exhaust source 412) with both sources of carbon dioxide exhaust source 412 being optimally fed into the integral gaseous storage 482. The power generation system 458 has a preferred optional energy storage device 4-116, an aggregate power consumption 4-114 across the electrically connected components within the co-location facility 4-104, a point parameter set 456 within a broader physical parameter set 446 (including an emissions profile 478 that optimally enables feedforward commands 114 to be generated.

The dual electrolyzer electrochemical system 420 produces a hydrogen stream using less than 20 kWh per kilogram of the resulting hydrogen stream by utilizing chemical potential energy pf the input organic matter (preferably sourced from within the on-site biomass growing facility 408/greenhouse 432 as known in the art). This enables the aggregate power consumption 4-114 of the data center 416 to be at least 2 percent lower with the dual electrolyzer electrochemical system 420 as compared to without the dual electrolyzer electrochemical system 420. Not all versions of thermally activated system 488 have been depicted as they can include biofuels, cellulose pulping, sugar, drying and mineral extraction facilities.

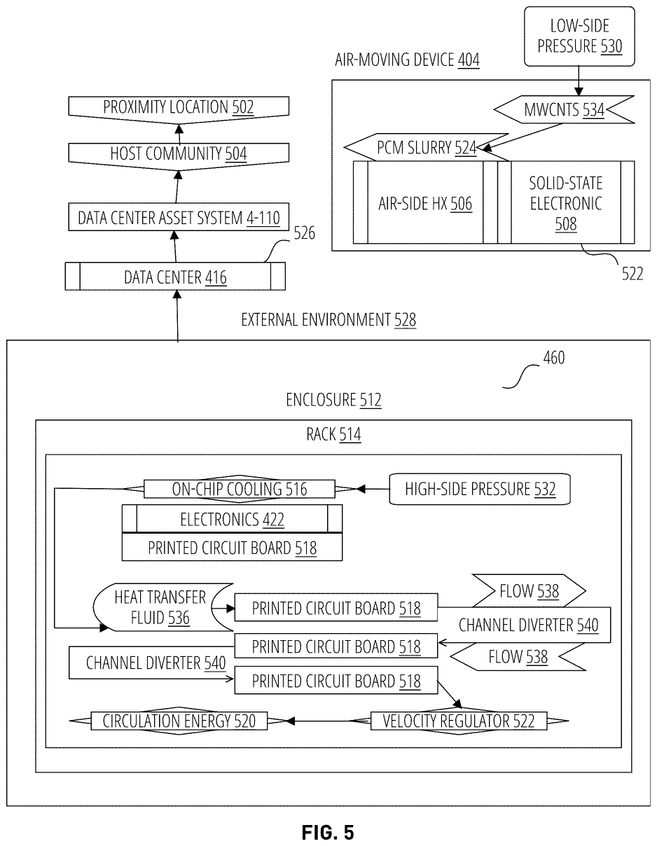

Turning to FIG. 5, FIG. 5 depicts an ultra-compact data center asset system 4-110 that is predominantly based (and preferably solely) on external thermal management interconnects of liquid (e.g., immersion cooling system 442 inclusive of in-direct liquid cooling system whether single phase or phase change) or preferably phase change fluids that are void of airflow 406 exchange between the internal volume 526 and external environment 528 of which two distinct thermal loops are present (a high-side pressure 532 and low-side pressure 530, where the latter is used for air cooling solely within the internal volume 526) to enable a more compact computationally dense format. The more compact data center asset system 4-110 reduces the requirements for Electromagnetic Interference “EMI” and/or Electromagnetic Pulse “EMP” (used in this context interchangeably). The preferred embodiment provides protection by implementing a multi-prong approach including having a corresponding reduction of surface area. The exterior surface 510 (i.e., weather-facing, and preferably sky-facing) is preferably an exterior surface 510 having both radiative cooling properties “radiative cooling system 460” nd EMI/EMP shielding (and the particularly preferred surface contains multi-wall carbon nanotubes 534 “mwcnts”, and the specifically preferred surface has emittance greater than 50 W per m2, preferably greater than 100 W per m2, more preferred greater than 200 W per m2, particularly preferred greater than 300 W per m2, and specifically preferred greater than 400 W per m2). The elimination of air exchange between the internal volume 526 and exterior further eliminates noise pollution to the host community 504 with additional gains by the coating having additional functionality to reduce the noise footprint by leveraging the mwcnts for sound dampening while not adversely impacting heat transfer (as compared to traditional foam-based as known in the art). The utilization of mwcnts for radiative cooling system 460, EMI/EMP shielding, and thermal spreading is then further comprised of the actual rack 514 enclosure 512 (for environmental isolation) to provide for a 2nd layer (at least a second) of EMI/EMP shielding and thermal cooling surface (ultra-high surface area realized by mwcnts, enhanced thermal conductivity, and therefore enhanced heat transfer) from the internal volume 526 airflow 406 to the low-side pressure 530 pressure liquid or phase change cooling heat transfer fluid 536. The internal volume 526 convection airflow 406 is preferably using solid-state electronic 508 air-moving devices 404 to virtually eliminate particulate fouling of interior thermal communication/heat transfer surfaces; and maximizing thermal isolation from the surrounding area. The inventive feature of the data center asset system 4-110 being moved from a first location to a second location (a proximity location 502) is best realized when the internal volume 526 of the data center asset system 4-110 has maximized thermal isolation from surrounding area to minimize susceptibility of adverse environmental exposure to minimize impact on surrounded area.

The particularly preferred active thermal surface provides thermal spreading, without being bound by theory, through radiative cooling system 460 (emissivity) and through-plane thermal conduction while also providing EMI/EMP shielding enhanced by the through-plane electrical conductivity all concurrently utilizing an in-plane thermal conductive pathway from the external environment 528 of the data center asset system 4-110 into the internal volume 526 of any data center 416 component (e.g., rack 514, server, printed circuit board 518). A specifically preferred embodiment has the in-plane thermal conductive pathway being multifunctional as both an active heat transfer surface and a structural element for the data center 416 module and preferably further providing also vibration isolation (especially required for deployable data center 416) of the electronics 422 within the data center 416 module. This combination substantially reduces the creation of hot spots particularly susceptible within very compact (i.e., having little free airspace) enclosed data center 416 module(s). High loadings of mwcnts 534 enhance the internal volume 526 airflow 406 heat transfer due to high surface area as known in the art including disrupting the boundary layer. Airflow 406 is created by any air-moving device 404 (preferably a solid-state electronic 508 type including electrohydrodynamic or piezoelectric) to provide an approximately horizontal (parallel to printed circuit board 518, understanding that printed circuit boards 518 can also be vertically mounted) airflow 406 creates an updraft into a high-surface area layer comprising solid loading of multi-wall carbon nanotubes 534 (exemplary can be virtually carbon product including single wall carbon nanotubes, graphene, etc.) preferably having metal end cap yielding higher through-plane thermal conductivity than in-plane which is subsequently in thermal continuity with a phase change material slurry 524 collectively being the air-side heat exchanger 506, thereby having an internal volume 526 requirement at least 2 percent (preferably at least 5 percent, specifically preferred at least 30 percent) lower as compared to an identical system without the phase change material slurry 524. The yet particularly preferred module conserves the airflow 406 momentum such that each individual printed circuit board 518 layer (e.g., containing microprocessor(s) and additional electronics 422) has airflow 406 on the first printed circuit board 518 flowing in a first parallel flow direction 538 and the second parallel printed circuit board 518 flowing in a second parallel flow direction 538 that is counter-flow to the first parallel flow direction 538 with an airflow 406 channel diverter 540 providing air communications between the airflow 406 of the first printed circuit board 518 and the airflow 406 of the second printed circuit board 518 (it is understood that this pattern can repeat multiple times such that each printed circuit board 518 is essentially stacked relative to the other printed circuit boards 518.

The specifically preferred embodiment is in thermal communications with the approximately same supply of phase change material slurry 524 providing cooling of the airflows 406 for each of the printed circuit boards 518. And it is also specifically preferred that the air-moving devices 404 are in parallel and interspersed between each segment of the air-side heat exchanger 506 with each air-moving device 404 preferably having an individual airflow 406 velocity regulator 522. The combination of channel diverters 540 between each printed circuit board 518 and interspersed air-moving devices 404 between each segment of the air-side heat exchanger 506 reduces the aggregate energy consumed by the air-moving devices 404 by at least 5 percent (preferably at least 10 percent, and specifically preferred at least 20 percent) as compared to equivalent thermal dissipation without any one of the channel diverter 540, phase change material slurry 524, and/or interspersed air-moving device 404 of the air-side heat exchanger 506. The utilization of the phase change material slurry 524 reduces the flow velocity over the air-side heat exchanger 506 to reduce the aggregate circulation energy 520 consumed to meet the thermal dissipation requirement of the air-side heat exchanger 506 by at least 5 percent (preferably at least 10 percent, and specifically preferred at least 20 percent) as compared to equivalent thermal dissipation without the phase change material slurry 524 which leads to lower pressure drop and to lower thickness of the air-side heat exchanger 506 by at least 5 percent (preferably at least 10 percent, and specifically preferred at least 20 percent). The specifically preferred data center asset system 4-110 is self-contained with no external airflow comprised of two distinct phase change loops with a first phase change loop providing direct on-chip cooling 516 (approximately on each printed circuit board 518) or immersion cooling system 442 (or understood to be liquid cooling system) and a second phase change loop providing air-side heat exchanger 506 cooling to have an internal volume 526 (being the total internal volume 526 of the entire data center asset system 4-110 e.g., racks 514 and cooling components) and aggregate energy consumed by the air-moving devices and aggregate circulation energy each being at least 5 percent (preferably at least 10 percent, and specifically preferred at least 20 percent) lower as compared to a data center asset system 4-110 without the channel diverter 540, phase change material slurry 524, and interspersed air-moving device 404 of the air-side heat exchanger 506.

The data center 416 is contained with the data center asset system 4-110 which is hosted by the host community 504 all located at a proximity location 502. The exterior surface 510 is exposed to the external environment 528, having a surface that provides concurrent EMI/EMP and radiative cooling system 460. The data center 416 is comprised of at least one rack 514 which has at least one server that typically contains at least printed circuit board 518 (those this invention with its superior thermal management enables printed circuit board 518 stacking as known in the art). The printed circuit board 518 is cooled both by a distinct and separate air cooling that is preferably in thermal communications with the low-side pressure 530 of a regenerative heat pump 434; and a liquid cooling system that is preferably in thermal communications with high-side pressure 532 of the same regenerative heat pump 434. The air cooling is comprised preferably of a phase change material slurry that is further comprised of multi-wall carbon nanotubes 534 in thermal communications with the air-side heat exchanger 506 having a solid-state electronic 508 device providing air movement (all collectively referred to as the air-moving device 404) that is in thermal communications through the printed circuit board 518 facing side of the air-side heat exchanger 506. The liquid cooling system is comprised preferably through on-chip cooling in which the chip is represented as electronics 422 that is physically mounted on the printed circuit board 518. The liquid cooling represented by the heat transfer fluid 536 repeating for each printed circuit board 518 (the 2nd through 4th instance of the printed circuit boards 518 do not show the details provided on the 1st, which is the top) for compactness). The particularly preferred embodiment of both the liquid and air cooling utilize phase change material slurry 524 so as to reduce the number of otherwise series flows for each printed circuit board 518 and further have channel diverters 540 with flow above the printed circuit board 518 being counterflow to the flow direction 538 below the printed circuit board 518. Each of the liquid and air cooling have velocity regulator 522 and circulation energy 520 consumption, though only depicted for the liquid cooling system in this figure.

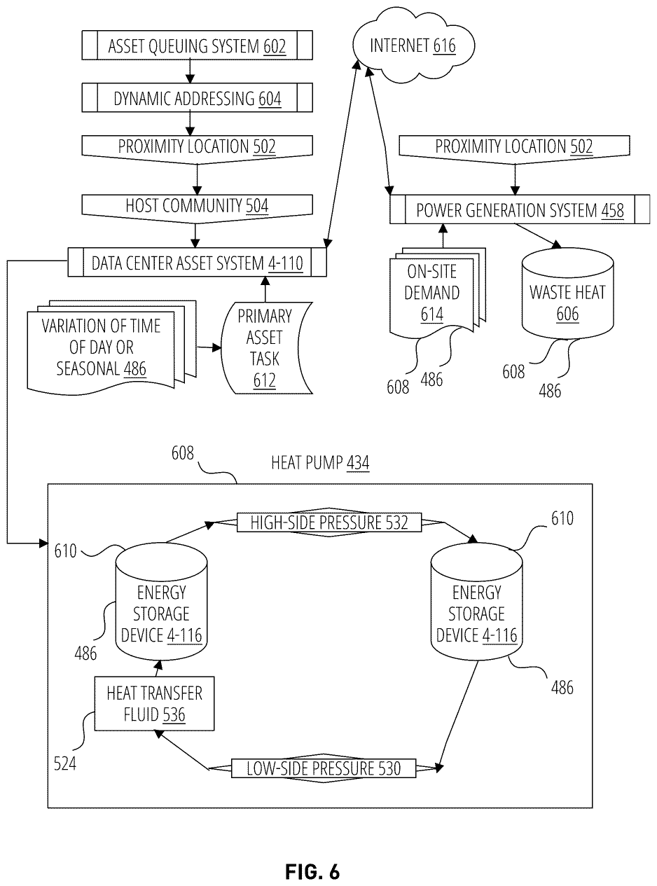

Turning to FIG. 6, FIG. 6 depicts deployable assets including the dynamic addressing 604 of ultra-compact data center asset systems 4-110. The fundamental reduction of data center asset system 4-110 size reduces both the logistics cost associated with movement amongst proximity locations 502 and the physical citing cost associated with hosting (i.e., smaller footprint as well as environmental isolation). The host community 504 benefits include a wide range of systems leveraging waste heat 606 such as water entertainment park, golf course, waste water, food production including greenhouse, road deicing, liquid desiccant regeneration, heating and cooling, domestic hot water; bio reactors including algae, photosynthesis of alternative protein, biofuel; and reducing energy requirements of electrochemical processes including hydrogen production, laundry drying and washing, dish washing, precast concrete curing, composite curing, and biomass drying.

Deployable assets that create waste heat 606, including the data center asset system 4-110 and power generation system 458, shift optimization model of energy intensive processes from the traditional energy efficiency optimization to operational cost optimization that even includes contrarian decisions to deploy assets with higher energy demand profiles 608 when the demand is able to be met using an abundance of waste heat 606 as compared to electrification of everything that typically uses less energy. One embodiment is liquid desiccant dehumidification utilized for atmospheric water harvesting, even though the net energy consumption per kg of water removed is substantially higher than practically every other water harvesting mechanism is, becomes dominant for data centers 416 largely due to on-site waste heat 606 whether directly from within the data centers 416 or power generation system 458 assets within the battery limits of the data center 416 both of which produce waste heat 606. A particular embodiment of liquid desiccant dehumidification is such that dehumidification of air at an at least one proximity location yields water upon regeneration that can be utilized at a first proximity location 502 (or second proximity location 502). Another embodiment is the utilization of waste heat 606 (Coefficient of performance “COP” virtually always less than 2.2 and dominated by less than 1.0) instead of a heat pump 434 (as shown in other figure) virtually always higher than 3 and dominated by greater than 4.0). This shift in execution strategy has the further advantage of increasing utilization factor for heat (greater than ambient temperature) consuming assets while decreasing utilization factor for cool (lower than ambient temperature) consuming assets.

When the waste heat 606 from the first proximity location 502 is thermally integrated with a regenerative heat pump the byproduct revenue also includes gains in revenue from at least one of air conditioning (“cooling” via the low-side pressure 530 of heat pump 434) or heating (via the high-side pressure 532). The further utilization of thermal energy storage device 4-116 on at least one of the low-side pressure 530 or high-side pressure 532 decouples the utilization of cooling from the utilization of the heating, and preferably enables the byproduct revenue derived from any of the individual or aggregate waste heat 606 from the first proximity location 502, plus waste heat 606 at second proximity location 502 by logistics of thermal energy storage device 4-116, and even waste heat 606 at any one of the at least one proximity locations 502. When the heat pump 434 is regenerative and the data center 416 requires air cooling then data center 416 queuing is based on on-site waste heat 606 requirement (net of on-site sources) including feedforward thermal energy storage capacity 610 requirement and the incremental cost of power (when off-peak is just energy cost, if peak is both demand and energy cost).

The dynamic addressing 604 placement of data center asset system 4-110 at locations deficient on the utilization of available waste heat 606 at a present location or 2nd location (i.e., proximity location 502) further provides the repositioning of data center asset system 4-110 or thermal energy storage devices 4-116 as a function “f( )” based on f(location, power generation waste heat 606, energy storage capacity 610, on-site thermal requirements, value of waste heat 606 that is further a function for primary thermal source that includes solar thermal or upgrading via heat pump 434); computational density, energy density, and power generation availability.

Deployability is particularly enhanced due to self-containment; closed loop water; self-containment with all liquid thermal management that displace more complex air thermal management; higher computation vs size and vs power enables larger candidate geofence placement having matching physical storage capacity or power capacity or thermal demand capacity; structural elements that are multifunctional including integral fluid (i.e., optimally phase change material slurry 524 or other phase change heat transfer fluid 536) piping and heat exchangers for active cooling; docking; operate with inherent evaporative cooling by compressing air to maintain maximum RH allowed; include COP of heat pump 434 and value of resulting cooling and heating as well as carbon dioxide “CO2” displacement ; waste heat 606 from power generation system 458 for temperature lift which can be consumed at a second location for third location consumption within the proximity locations 502; or even the alternative deployable where a heat pump 434 provides subsequent temperature lift for thermal energy storage device 4-116 or power generation system 458 where the heat pump is at first proximity location 502 and the utilization of the stored energy is at a second proximity location 502.

Data centers 416, just like other mission critical equipment in facilities including cold storage warehouse, and hospitals, typically include either primary or backup power generation systems 458. Unlike cold storage or hospitals, an ultra-compact data center asset system 4-110 can be moved accompanied with any co-located power generation systems 458 to a proximity location 502 in order for a host community 504 to benefit from a wide range of electricity consuming systems leveraging the otherwise under-utilized power generation system 458 supporting the data center asset system 4-110 such as electric vehicle “EV” charging particularly preferred to be utilizing swappable batteries, deployable power, refrigeration equipment, lighting, etc. The backup power generation system 458 or excess capacity of underutilized power generation system 458 is optimally used for the aggregate of electricity at first proximity location 502, plus electricity at second proximity location 502 by way of logistics of electrical energy storage device 4-116 to create substantial byproduct revenue opportunities for the host community 504. The unique ability for data center 416 operations to be transition rapidly moved from a first proximity location 502 to a second proximity location 502 amongst the proximity locations 502 due to primary asset task 612 not performed on physical inventory provides optimization decisions to include movable fleet of vehicles, data center 416 modules, power generation system 458, energy storage device 4-116, and stationary as well as mobile energy consumers (electrical or thermal). Another embodiment of an ultra-compact data center asset system 4-110 is the further inclusion of wheels for mobility having the further advantages of faster permitting (viewed as a temporary positioned asset rather than a fixed asset) and rapidly reconfigurable to keep up with technological improves including enhanced computational density, power density, and thermal density. Continued technology gains continue to reduce internal volume 526 of the data center asset system 4-110 increasing the opportunities for deployment of data center asset systems 4-110 to maximize host community 504 benefits, in addition to dynamic changes in availability and capacity of grid interconnect, power conversion, power bus, thermal bus, thermal and/or electrical on-site demand 614 for non-data center asset system loads, real estate footprint, Internet 616 communications, power backup, and even cooling.

As known in the art, power generation systems 458 operate best at peak ratings for highest energy conversion efficiency, However, operating on-site power generation system 458 equipment for maximum utilization at highest energy conversion efficiency (though enable on/off cycling of power generation equipment) is most often contrary to data center asset system 4-110 loads therefore deploying data center asset systems 4-110 to proximity locations 502 such that the aggregate of connected loads (not having the inherent location flexibility) achieves maximum aggregate cost savings of all connected loads across the entire network (i.e., not a single location, not a single client, not a single function) and is the particularly preferred embodiment where data center asset systems 4-110 are moved (including reconfiguration of total size) whether in combination or decoupled from cooling assets, and/or power generation system 458 assets. A fundamental recognition that each location has a primary alternative operating cost structure (that can even include in front of the meter a.k.a. Grid and/or behind the meter a.k.a. Microgrid) and operational and byproduct revenue stream that has variation of time of day or seasonal 486 driving the placement of each and every asset through an inventive asset queuing system 602.

The particularly preferred embodiment has the asset queuing system 602 comprised of a dynamic addressing 604 system that includes each proximity location 502 having at least one host community 504 and specifically preferred to have at least one data center asset system 4-110. The data center asset system 4-110 coordinates the performance of primary asset tasks 612 (and secondary asset tasks 802 though not shown in this figure). It is understood and preferred that particularly preferred coordination of the primary asset tasks 612 and secondary asset tasks 802 though not shown in this figure of both a feedforward and feedback loop control system 130 as a further function of variation of time of day or seasonal 486; all having communications as known in the art notably the Internet 616 (which is also communicating to any on-site and off-site (i.e., at a different proximity location 502) power generation system 458 (though not show in this figure has operational byproduct 704 of waste heat 606) where both the power generation system 458 and waste heat 606 are functions of at least one of energy demand profile 608 and variation of time of day or seasonal 486. Though not shown in this figure it is understood that the high-side pressure 532 can be upstream of power generation system 458 waste heat 606 in which waste heat 606 from the data center 416 is temperature lifted to the higher operational byproduct 704 waste heat 606 of the power generation system 458. The preferred heat pump 434, though not showing in this figure the full set of components as known is a regenerative type, in which control is a function of energy demand profile 608. Particularly preferred is that both the high-side pressure 532 and low-side pressure 530 have individual and distinct thermal energy storage devices 4-116 each having energy storage capacity 610 and variation of time of day or seasonal 486. The preferred heat transfer fluid 536 is a phase change material slurry 524.

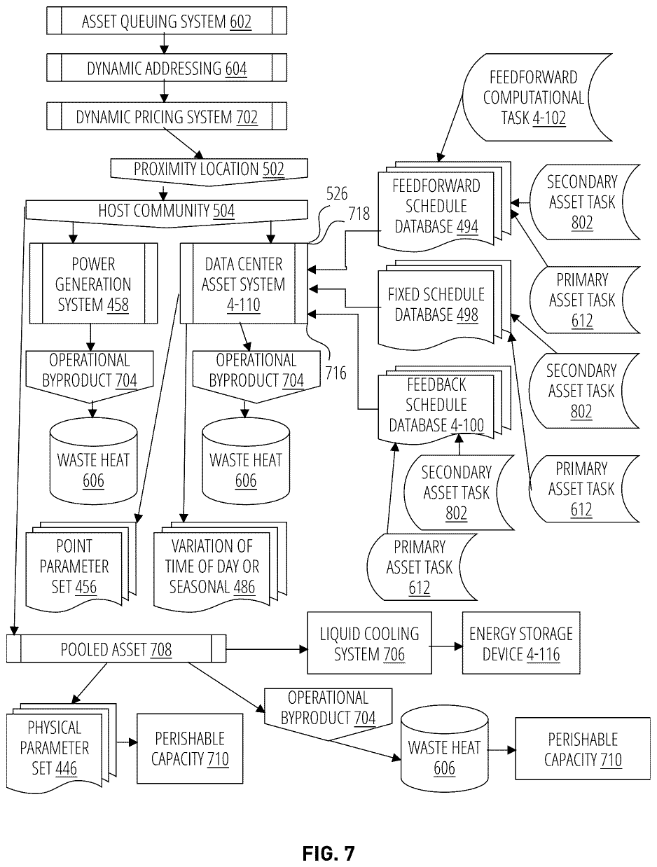

Turning to FIG. 7, FIG. 7 addresses the dynamic addressing 604 and dynamic pricing system within the context of the asset queuing system 602 (a.k.a. QueView) for movement and placement of assets at least utilizing a feedforward schedule database 494, preferably in which operational byproduct 704 revenue streams are factored into dynamic pricing system 702 of primary asset task 612 notably and inclusive of data center asset systems 4-110. The particular preferred embodiment further includes feedforward computational tasks 4-102 within at least one of a fixed schedule database 498 and a feedback schedule database 4-100. Primary asset task 612 include computational tasks for the data center asset system 4-110 in addition to support power generation system 458 tasks and cooling tasks for data center asset system 4-110 operations.

When the preferred at least one proximity location has available physical space for at least one computational asset (a portion of the data center asset system 4-110) that otherwise would be placed in a dedicated first proximity location 502, a computational asset that preferably has a high power density requirement (and therefore produces a corresponding operational byproduct 704 of waste heat 606) the at least one computational asset is deployed to the at least one proximity location 502 in accordance to the feedforward schedule database 494. When the supporting power generation system 458 is also deployed to the at least one proximity location 502 (or is already present with spare capacity to support the at least one computational asset) waste heat 606 revenue is realized as a host community 504 benefit whether the waste heat is by operating the computational asset of the data center asset system 4-110 and/or by power generation system 458 waste heat 606. The feedforward schedule database 494 accounts for the preconditions of available physical space and waste heat 606 revenue being greater than any loss of revenue due to logistics downtime plus cost of logistics during transit of the at least one computational asset to the at least one proximity location 502.

The asset queuing system 602 of the aggregate network queue has a queue allocation engine to the at least one proximity location 502 having spare electricity capacity and having spare waste heat requirement and accounting engine to calculate the dynamic value of revenue for the waste heat as function that an alternative pathway of creating the approximately same amount of waste heat considering the cost of making that waste heat accessible specifically including the COP of a heat pump (as shown on other figure) at the same at least one proximity location 502. The dynamic value of revenue further includes revenue of cooling notably when the heat pump is a regenerative heat pump that further considers the cost of making the approximately same amount of cooling accessible beyond the cost of making the waste heat accessible. Then repeating the placement algorithm on a minimum time duration at a first location using feedforward for the next minimum time duration at first location; then including feedforward for the next minimum time duration at second location considering logistics cost and downtime. The asset queuing system 602 and the feedforward schedule database 494 take into account the energy density of power generation system 458 assets vs. available physical space, computational density of data center asset system 4-110 asset vs. available physical space and the logistics cost taking into account the internal volume 526 of the deployable computational assets such that a higher computational density all things equal has a lower logistics cost relative to computational assets having a lower computational density.

The asset queuing system 602 operating model is based at least in part on the replacement value of the computational assets within the data center asset system 4-110 (recognizing that the original purchase price is a sunk cost), the electricity operating cost minus revenue value including feedforward value based on operational byproduct 704 value streams including waste heat as compared to dynamic pricing system 702 and on-site demand of waste heat (displacement cost as well as heat pump COP adjusted cost). The logistics cost of deploying the resulting waste heat 606 to a proximity location 502 from a first proximity location 502 is included in the operating model as well to determine the real cost benefit to the host community 504 at the proximity location 502 in comparison to incremental cost of other available sources of thermal energy whether it be waste heat (power generation system, regenerative heat pump or computational asset) or solar thermal heat already at that same proximity location 502.

The asset queuing system 602 operating model further includes operational byproduct 704 revenue attributed to incremental revenue associated with superior emissions profile (i.e., lower greenhouse gas emissions priced at dynamic market carbon sequestration rates). Additional revenue further includes at least a portion of new operational byproduct 704 revenue opportunities derived from carbon dioxide emissions due to power generation system 458 operations, including revenue notably from microalgae or alternative protein growth or even methanol production from as known in the art carbon dioxide plus hydrogen reactions all of which are substantially higher operational byproduct 704 revenue sources compared to dynamic market carbon sequestration rates. Deploying computational assets and/or power generation systems to a proximity location 502 able to utilize emitted CO2 shifts the location preference significantly due to the otherwise high cost of processing for transport any carbon dioxide emissions from a first location.

Contrary to the as known in the art, the asset queuing system 602 optimizes for profit via revenue maximization inclusive of operational byproduct 704 revenue as compared to traditional optimization based on operating cost reduction. Allocating computational tasks of the as known in the art optimization on operating cost reduction fail to differentiate between a first location having excess renewable energy (whether nuclear, solar or wind) from a second location also having excess renewable energy (also whether nuclear, solar or wind) that essentially have approximately identical incremental operating costs. The preferred asset queuing system 602 accounts for the placement of used (or relatively older technology) and therefore also less energy efficient computational asset (e.g., servers whether CPUs or GPUs) into at least one proximity location 502 (i.e., a host community 504 needing waste heat 606) particularly prioritized where such waste heat displaces higher operating cost assets that produce thermal energy (e.g., boiler, furnace) from propane, natural gas, or diesel fuels or even electricity driven assets (e.g., heat pump, furnace). At the very least the preferred asset queuing system 602 accounts for operational byproduct benefits (whether translated into revenue or not) recognizing the contributions of the host community 504 providing placement of computational assets translating to reduced operating costs by effectively reducing physical space rental and even more important in this time of grid interconnect queuing providing electricity accessibility. Queuing within the feedforward schedule database 494 to meet both real-time demand and feedforward of at least one of thermal demand and thermal buffers (including other thermal source predictions) is fundamental in the calculation of operational byproduct 704 revenue attributed at least in part to waste heat from the computational assets and/or power generation system assets.

Queuing within the feedforward schedule database 494 to meet deployable data center asset system 4-110 in accordance to demand reduction from a first location to an at least one proximity location 502 at a host community 504 enables placement of assets to reduce demand costs that far outweigh incremental energy costs in many instances. Additional features of the asset queuing system 602 include location minimum operating conditions including capacity authentication of communications (preferably accounting for feedforward predictive communication demands), available electricity, physical access to docking or interconnection ports for deployable pooled assets 708, data center 416 assets or power generation systems assets. The asset queuing system further includes communications authentication engine to establish preliminary prevention of data leakage, preliminary authentication router to reduce real-time latency delays and Cloud Access Security Broker (CASB) systems.

The feedforward schedule database 494 preferably scheduling assets by the depreciation rate in which the primary depreciation function is based on acquisition price, and the secondary depreciation function is based on decreasing equipment lifetime based on replacement value. It is understood that the particularly preferred scheduling is more heavily weighted on secondary function recognizing that the primary function is actually a sunk cost. Queuing of assets is heavily weighted to include operational byproduct value and/or revenue attributed to proximity location creation of co-created carbon products from on-site power generation systems preferably higher value carbon nanotubes (such as from as known in the art methane pyrolysis), waste heat, cooling from regenerative heat pumps, and/or the placement based on excess capacity utilization of assets (e.g., power generation system, heating and/or cooling), CO2 utilization and insurance value attributed to backup power generation system and/or cooling assets. The particularly preferred asset queuing system 602 utilizes the feedforward schedule database 494 as a function of the ratio within the aggregate network of first locations and proximity locations 502 primary depreciation function 718 to secondary depreciation function 716 with a ratio less than 1:1 and preferentially less than 1:2, a range of 1:1, 1:2, 1:3, 1:4, 1:5 through 1:20 (explicitly any continuous range from 1:1 to 1:20). The particularly preferred asset queuing system 602 also has a ratio of data center asset system 4-110 internal volume 526 to proximity location 502 physical space ratio less than 1:1 and preferentially less than 1:2, a range of 1:1, 1:2, 1:3, 1:4, 1:5 through 1:20 (explicitly any continuous range from 1:1 to 1:20); a ratio of waste heat 606 production at first locations to utilization of excess capacity for behind-the-meter impact ratio of waste heat 606 and cooling derived concurrent with waste heat utilization at proximity locations 502 less than 1:1 and preferentially less than 1:2, a range of 1:1, 1:2, 1:3, 1:4, 1:5 through 1:20 (explicitly any continuous range from 1:1 to 1:20), and specifically preferred also a function of the economic value created at proximity locations 502 for electricity and thermal energy (heat and cool) price decreases attributed to the co-location of power generation system 458 and thermal assets based on the as known in the art non-linear decrease in per unit cost and energy efficiency gains (i.e., a 500 kW heat pump has a higher COP compared to a 50 kW heat pump, therefore a single 500 kW heat pump consumes less energy for approximately equivalent creation of heat source and cooling source vs. 10 units of each 50 kW heat pump). This fundamental gain in efficiency, also often realized in power generation systems, further increases the optimal shift of less data center asset systems 4-110 at first proximity location 502 to more data center asset system 4-110 at proximity locations 502 524. All things equal the asset queuing system 602 has ratios less than 1:1 and preferentially less than 1:2, a range of 1:1, 1:2, 1:3, 1:4, 1:5 through 1:20 (explicitly any continuous range from 1:1 to 1:20) for data center asset systems 4-110 a) computational per energy density, b) computational per internal volume 526 density, and c) combined computational density and waste heat and cooling utilization factor at first locations to proximity locations 502 volumetric density.

The dynamic pricing system aggregates operating cost for each of a first operating cost at the first proximity location and an at least one second operating cost at the second proximity location with an aggregate location revenue that is the sum for each revenue stream for the first proximity location and for each of the at least one second proximity locations and also accounts for the accounting costs by reducing the aggregate location revenue by a primary depreciation function and secondary depreciation function. The aggregate network revenue sums the aggregate location revenue for the first proximity location and for each of the at least one second proximity locations and optimizes in order to at least increase by at least two percent higher (preferably at least five percent, and specifically preferred at least ten percent) with the dynamic pricing system by including the accounting cost amortization adjustment rate for each of the first proximity location and for each of the at least one second proximity locations as compared to the absence of accounting for the value of each of the primary depreciation functions and secondary depreciation functions for the first proximity location and for each of the at least one second proximity locations

the operating costs comprised of a first operating cost at the first proximity location and an at least one second operating cost at the second proximity location by aggregate for each location an aggregate location revenue that is the sum of a revenue stream for the first proximity location and for each of the at least one second proximity locations. The dynamic pricing system also has an aggregate network revenue that is the sum for each location the aggregate location revenue for the first proximity location and for each of the at least one second proximity locations. This embodiment results in the aggregate network revenue being at least two percent higher (preferably at least five percent, and specifically preferred at least ten percent) with the dynamic pricing system when including a value for each of the operational byproducts for the first proximity location and for each of the at least one second proximity locations as compared to the absence of accounting for the value of each of the operational byproduct for the first proximity location and for each of the at least one second proximity locations.

Furthermore, the asset queuing system places data center asset systems 4-110 at increasing rates within proximity locations 502 for the host community 504 to gain from telecommunications speed, capacity, higher utilization especially for machine learning computational primary asset tasks 612 (or secondary computational tasks) where the ratio of inbound communications to outbound communications is higher for proximity locations 502 as compared to first locations resulting in real economic benefit to the host community 504 (that in many instances, especially as the technology trend of computational energy density decreases dramatically and quantum communications dramatically increases telecommunications speed, the energy operating cost diminishes relative to the aggregate host community 504 economic benefits). Once the host community 504 aggregate economic benefits become greater than data center asset system 4-110 operating energy costs the asset queuing system 602 will dynamically lead to large quantities of much smaller data center asset systems 4-110 leading to accompanied network benefits of increased resilience, diminished operating costs by effective elimination of physical space rental, and reduced capital costs by effective pooled assets 708 including power generation system 458, heating and cooling assets. The asset queuing system 602 is further comprised of a reconfiguration engine for conversion of computational assets from predominantly air-cooling system to predominantly liquid or immersion cooling system thermal management to increase operational byproduct revenue opportunities. Additionally, placement of computational assets at proximity locations is such that relatively less efficient FLOPS per energy are preferably dynamically placed at locations having lower energy costs.

A summary of mutual benefits (data center asset system owners/operators and host community) of proximity location placement (as compared to dedicated standalone first location) includes: lower real estate occupancy costs (i.e., rent especially where co-location has vacancy); lower security cost; shared backup power has impact of reducing insurance cost in the event of power loss; shared meet-me rooms that become multifunctional with higher utilization factor; shared fire-suppression system; shared telecommunications, especially where co-location has substantial download requirements that can be offset by substantial upload requirements of machine learning; larger power, heating and cooling assets have higher energy efficiency per unit of production and lower capital acquisition cost per unit of production; and variable employee workloads as f(t) provides opportunities to increase personnel utilization by cross-training of primary tasks and secondary tasks, including preventative or reactive maintenance tasks. The latter cross-training of employees becomes even more critical (and cost saving) as the frequency of failed computational assets decreases substantially with superior thermal management (i.e., phase change vs. air cooled) and the rate of incidence decreases substantially with smaller number of electronics and printed circuit boards at each proximity location.

The trend to smaller standalone data centers more properly sized match for enhanced co-location at proximity locations mutual benefits accelerates with future technology gains such as: substantially lower energy cost per FLOP yielding further ratio shift of capital costs: operating costs; substantially higher computational power density, and higher computational volumetric density; higher communications speed leads to reduced communications latency opening up co-location opportunities. The aggregate of computational assets ratio at first locations to proximity locations within the asset queuing system 602 has peak power rating from 0.05:1.0, 0.1:1.0, 0.5:1.0, to 2:1; peak thermal heating rating from 0.05:1.0, 0.1:1.0, 0.5:1.0, to 2:1; and peak thermal cooling rating from 0.05:1.0, 0.1:1.0, 0.5:1.0, to 2:1.

The vast network of computational assets placed at proximity locations 502, especially with dynamic addressing 604 for deployable assets requires pre-authorization methods to prevent data leakage, maintain data integrity, prevent data hacking and even unauthorized asset utilization. The asset queuing system includes pre-authorization methods enabling a computational asset to switch dynamically between performing primary (dedicated to host community) computational tasks and secondary (non-dedicated to host community) computational tasks and vice versa, whether the asset is stationary or deployable. Performing the pre-authorization method in advance reduces the effective latency time, which is of particular importance as the starting latency time for secondary computational tasks already has a latency deficiency compared to primary computational tasks that further exacerbates this latency penalty. Each computational asset has f(t) replacement capital cost per FLOP, replacement capital cost per operating unit of time, maintenance cost per operating unit of time, maintenance cost per operating FLOP. Exemplary assets include computational assets acquired for primary computational tasks (e.g., smartphone, autonomous vehicle; vision systems for security, facial recognition, weather, traffic control) having substantial excess capacity that is otherwise perishable capacity 710. Additional instances of significant perishable capacity 710 computational assets having variations variation of time of day or seasonal 486 operations including: nighttime for solar energy systems or low-wind speeds for wind energy systems, relatively straight or less complex travel for autonomous vehicles such as not at intersections or on/off ramps, weather conditions not driving heating or cooling demand, low personnel or guest occupancy for hospitals, hospitality, entertainment venues such as sports stadiums or live theatre, transportation centers such as train stations or airports, and even security systems for facilities having extended periods of time in which the facility is closed. Other computational assets have primary computational tasks include: weather forecasting; scientific computing including structural and materials analysis, and simulation computations; high computational video and creative content creation including 3d rendering and animation; computer-aided design and engineering; high-frequency trading; fraud detection; insurance risk modeling; gaming computers including at casinos, etc. ; and academic institutions all of which can be scheduled in the fixed schedule databases 498 or preferably in the feedforward schedule databases 494.

The asset queuing system 602 includes point parameter sets 456 and physical parameter sets 446 that has specific parameters such as energy projections all f(t) for electricity, thermal hot, thermal cold: Energy kWh per FLOP, demand kW per FLOP, @ co-location (for each available energy source and storage device—(kWh) lower threshold & upper threshold, available demand (kW) lower threshold & upper threshold, energy cost function, energy demand cost function, energy price function, energy demand price function, critical temperature for each source, heat COP, cool COP, combined heat and cool COP Displaced cost for combined heat and cold, displaced cost for just heat, displaced cost for just cold. All things equal, less efficient computational asset on a FLOPS per power consumption rating are placed at co-locations having a lower displaced COP of on-site heating and/or cooling assets. An additional parameter accounts and differentiates for displaced CO2 emissions for combined heat and cold, displaced cost for just heat, and displaced cost for just cold. Additional parameters further include: Queuing Process all f(t) Predicted Primary Tasks, Predicted Primary Tasks Aggregate Energy, Predicted Primary Tasks Aggregate Energy for @ Primary Task, Predicted Primary Tasks Aggregate Thermal Energy for @ Primary Task, Predicted Primary Tasks Aggregate Revenue for @ Primary Task, Predicted Primary Tasks Aggregate Cost for @ Primary Task, Instantaneous Queuing Capacity for @ Primary Computational Asset; repeat for @ Secondary Task. It is understood that primary tasks and secondary tasks are not solely computational tasks, but rather primary tasks are defined by predominant task driving acquisition of asset performing the primary tasks and secondary tasks are virtually any other task that is not a primary task.

Each proximity location 502 has physical parameter sets 446 and point parameter sets 456 that include f(t) physical footprint available capacity (i.e., physical space), physical volume available capacity, docking pad available capacity for mobile, docking pad available capacity for stationary, communications available capacity through operations, secondary impact revenue from excess power capacity through operations (e.g., insurance value of having a backup power source), secondary impact revenue from excess heating capacity through operations, secondary impact revenue from excess cooling capacity through operations, secondary impact revenue from other byproducts through operations (e.g., CNTs, RIN credits, CO2), communications available capacity through standby, secondary impact revenue from excess power capacity through standby (e.g., insurance value of having a backup power source), secondary impact revenue from excess heating capacity through standby, secondary impact revenue from excess cooling capacity through standby; excess latency time penalty, excess communications speed penalty. It is understood that excess capacity of power, heating and/or cooling can be stored to shift from real-time production to future consumption, whether it be at current co-location or transported for subsequent future consumption at a next co-location (preferably account for logistics cost from a first current co-location to a second future co-location). Relatively low-variability load factors for waste heat utilization includes manufacturing operations (e.g., food, paper/pulp, desalination, biomass).

The asset queuing system 602 for power generation systems 458, including for data center asset systems 4-110, has an on-site energy storage capacity 610 to deployable energy storage capacity 610 ratio less than 1:1 and preferentially less than 1:2, a range of 1:1, 1:2, 1:3, 1:4, 1:5 through 1:20 (explicitly any continuous range from 1:1 to 1:20). The asset queuing system 602 for power generation systems 458, including for data center asset systems 4-110, has an on-site energy storage capacity 610 to deployable power generation system 458 energy production energy storage capacity 610 ratio less than 1:1 and preferentially less than 1:2, a range of 1:1, 1:2, 1:3, 1:4, 1:5 through 1:20 (explicitly any continuous range from 1:1 to 1:20). The preferred ratio is lower for corresponding lower periods of time having a lower probability threshold of electric grid disruptions. The preferred ratio is lower for corresponding lower periods of time having a lower logistics distance of deployable power generation systems 458 or deployable thermal energy storage capacity 610 at an at least one available proximity location 502. The asset queuing system 602 for cooling systems, including for data center asset systems 4-110, has an on-site thermal energy storage capacity 610 to deployable thermal energy storage capacity 610 ratio less than 1:1 and preferentially less than 1:2, a range of 1:1, 1:2, 1:3, 1:4, 1:5 through 1:20 (explicitly any continuous range from 1:1 to 1:20). The asset queuing system 602 for thermal management systems has an on-site thermal energy storage capacity 610 to deployable thermal energy storage capacity 610 ratio or to deployable power generation system 458 energy production energy storage capacity 610 ratio less than 1:1 and preferentially less than 1:2, a range of 1:1, 1:2, 1:3, 1:4, 1:5 through 1:20 (explicitly any continuous range from 1:1 to 1:20).

As noted the asset queuing system 602 has a dynamic addressing 604 and dynamic pricing system 702 that includes each proximity location 502 having at least one host community 504, with each host community 504 preferably having a power generation system 458 and data center asset system 4-110. As noted earlier the power generation system 458 and data center asset system 4-110 preferably have operational byproduct 704 with their respective waste heat 606. Each asset whether a pooled asset 708 (not shown), power generation system 458 or data center asset system 4-110 has both physical parameter set 446 and a point parameter set 456 (parameters changing as a function of physical location notably proximity location 502 or more specific locations as a subset of locations or geofenced locations within the proximity location 502 and specifically is also a function of variation of time of day or seasonal 486, preferably physical parameter set 446 may even be a further function of point parameter set 456. Importantly perishable capacity 710 is a critical parameter within the physical parameter set 446 (even when not explicitly shown in each figure). It is further understood that any pooled asset 708 can have multiple operational byproducts 704 though most figures depict waste heat 606 as the “only” byproduct. The particularly preferred data center asset system 4-110 is comprised of at least one of a feedforward schedule database 494, fixed schedule database 498, and a feedback schedule database 4-100 each having at least one set of primary asset tasks 612 and secondary asset tasks 802. Further, the feedforward schedule database 494 preferably also contains feedforward computational tasks 4-102. Yet further, the pooled asset 708 (on the bottom left) depicts a liquid cooling system 706 having an energy storage device 4-116 decoupled from a power generation system 458 and also a data center asset system 4-110.

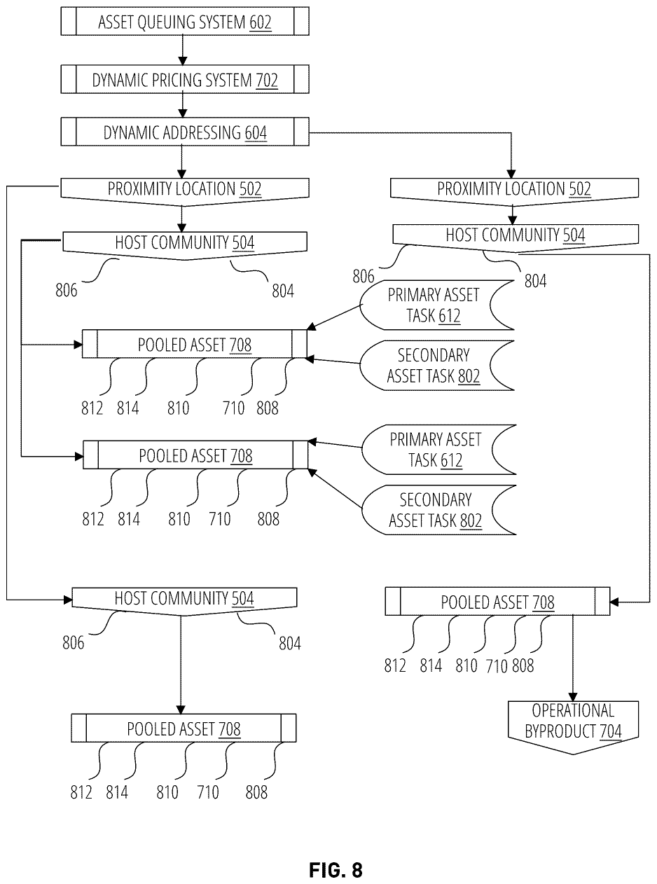

Turning to FIG. 8, FIG. 8 addresses the dynamic pricing system 702 component for billing within pooled assets 708 whether the assets are: deployable from a first proximity location 502 to a second proximity location 502 where the asset performs primary asset task 612 at both proximity locations 502, deployable from a first proximity location 502 where the asset performs a primary asset task 612 at one location (typically the first proximity location 502) and secondary asset tasks at one or more proximity locations 502, or even non-deployable at a proximity location 502 where variations variation of time of day or seasonal 486 provides a basis to switch between primary asset task 612 and Secondary asset tasks 802 (most notably where the asset tasks are computational tasks where multiple beneficiaries realize value without any physical movement of assets or inventory for computational assets or charging of energy storage devices 4-116 for power generation system 458 assets in which primary asset task 612 are for benefit of host community 504 and secondary asset tasks 802 are for benefit external of host community 504). A fundamental feature of the dynamic pricing system 702 is to differentiate pricing between primary asset task 612 and secondary asset tasks 802, and furthermore to be a function of the pooled assets 708 ratio of time performing primary asset task 612 to time performing secondary asset tasks 802. A further feature of the dynamic pricing system 702 inherently recognizes that a higher utilization factor leads to a lower amortization rate on a time usage basis as performing more secondary asset tasks 802 effectively decreases the cost basis for performing primary asset task 612. Contrary to the concept of net metering in the renewable energy business that has approximately equivalent pricing of primary asset task 612 and Secondary asset tasks 802 or even worst where primary asset task 612 have value to host community 504 substantially higher than realized pricing of Secondary asset tasks 802, the dynamic pricing system 702 recognizes that Secondary asset tasks 802 can have value greater than primary asset tasks 612 value (e.g., utilization of asset during peak demand periods are more valuable than utilization of asset when demand is below peak demand). The ability of otherwise host community 504 at a first proximity location 502 to realize greater value than a second proximity location 502 encourages schedule shifting such that an otherwise dedicated stationary asset becomes a pooled asset 708 (even if just temporarily) all of which is accounted for via dynamic pricing system 702 through dynamic addressing 604 for placement of asset through asset queuing system 602 to a network of proximity locations 502.

A preferred embodiment of the asset queuing system 602 leverages a network of power generation system assets including energy storage devices such that either permanent energy storage device asset remains at a host community and a pooled asset 708 (a deployable power generator) moves from a proximity location 502 that requires operational byproduct 704 waste heat 606 resulting from the operating deployable power generator (as compared to be permanently within a host community 504 not requiring that waste heat 606) such that the logistics time to move the deployable power generator from the proximity location 502 to the required host community 504 (experiencing as per parameter the backup energy capacity shortfall) is lower than the amount of time available for the permanent energy storage device 4-116 at the host community 504 experiencing the backup energy capacity shortfall to provide available stored energy until the deployable power generator arrives to then provide power exceeding the backup energy capacity shortfall. This dynamic addressing 604 for pooled assets 708 increases the utilization factor, reduces amount of underutilized assets whether it be energy storage devices 4-116 or power generation systems 458 simply standing by in idle mode, while monitoring at least one parameter from the host community 504 point parameter sets 456 and/or physical parameter sets 446.

The billing system utilizing dynamic pricing system 702 accounts for computational assets performing between primary asset tasks 612 and secondary asset tasks 802, time at which tasks are performed inclusive of peak vs. off-peak rate, allocation of costs differentiated between beneficiary of host community 504 or proximity location 502. These tasks are for computational assets, or heating, cooling, communications, power generation, and/or backup power assets on standby for potential deployment (preferably as a function of prioritization established by the asset queuing system 602). Dynamic pricing system 702 is also a function of time ahead scheduling (the more time between in-queue and demand for task completion has a higher task completion rate, avoiding financial penalties). The billing system further includes provisions of an “insurance policy” recognizing that the inherent value of pooled assets 708 being effectively available to meet the functionality of otherwise permanent in standby mode assets even though the pooled asset 708 is located at a proximity location 502. The particularly preferred billing system specifically accounts for realized value of additional host beneficiary tasks to the host community.

The dynamic pricing system 702 differentiates between computational task completion cost, faster completion time premium, slower response penalty waste heat demand, waste heat 606 energy storage device 4-116; also cooling demand and cooling energy storage device energy storage device 4-116 with regenerative heat pump 434 (another potential incremental revenue), communication capacity, latency penalty metrics, data storage capacity, data transfer cost basis, energy excess, and/or cost penalty/basis; risk of power outage penalty, computational capacity excess, amortization basis, data and physical security levels, variability levels for proximity locations 502 within specific geofences, and physical space rent revenue or lease cost. It is understood that multiple time domains for example of data transfer at t1 for computation at t2, and data transfer of results at t3 provide basis for dynamic pricing system 702.

Dynamic pricing system 702 is also required for deployable power, thermal energy, decoupling power and waste heat, also cold and hot demand; and waste heat value that is f(waste heat from on-site power generation including solar thermal, weather, heat pump 434 COP which can also be as a function of heat pump 434 electricity if regenerative then as a function of cooling demand and value). In other words, dynamic pricing system 702 starts with demand for heating, then on to demand for cooling (when utilizing a regenerative heat pump 434), and alternative sourcing availability of electricity having its respective real-time pricing. The inclusion of seasonal variability, projection of revenue, and logistics costs for movement from a first proximity location 502 to a second proximity location 502 are all factored in establishing dynamic pricing. The dynamic pricing system 702 further differentiates between optimizing for aggregate host community 504 savings, or solely for asset owner profits recognizing that ROI of pooled assets 708 must optimally include not just owner revenue but also host community 504 savings.

The billing system (and revenue “dividend” system) incorporates “trading” of high-margin to low-margin between distinct beneficiaries. The ultimate model utilizes a required large-scale asset having perishable capacity 710 to displace high margin direct to consumer benefits. The best of these assets is accessible, though without limitation to not requiring any physical logistics requirements, such as wireless communications including access to entertainment streaming, tokenized software utilization, etc. The billing system and therefore the asset queuing system 602 recognizes that consumers for various reasons elect to have financial certainty in their purchasing decisions which substantially influence how, when and where individual financial decisions are made. Exemplary decisions include leasing of mobility vehicles, rental of apartments and homes, unlimited data and voice in wireless communications services, and all-inclusive hotels and resorts all of which enable incentives for pooling of assets that inherently have substantial periods of excess perishable capacity 710. The billing system further provides individual consumers that on an approximately daily basis consume bottled water, soda whether fountain or can, French fries, potato chips, coffee and tea as exemplary consumables with the bulk of these items having a very high gross margin as calculated as the differential between manufacturer production cost and consumer purchase price to contribute their individual assets into pooled assets 708 (even if that pooling is engaged on a variation of time of day or seasonal 486 schedule). Such assets include personal assets at a first location including mobility vehicles or personal/corporate physical space (i.e., ranging from a room to an apartment or home), including autonomous vehicles 496, especially when a personal asset is concurrently contributed to a pool of assets at a second location. It is understood that the inventive feature doesn't require concurrent utilization of a first personal asset at a first location to a second personal asset at a second location, though in this instance a personal asset billing parameter (i.e., point parameter sets 456) at least includes one of the amount of time the asset is contributed to the pooled assets 708 and the frequency of occasions the asset is contributed to the pooled assets 708; and preferentially also the amount of time the asset is utilized from the pooled assets 708 and the frequency of occasions the asset is utilized from the pooled assets 708. It is further understood that the first personal asset being contributed by a first person to pooled assets 708 is not required to be approximately identical to the first personal asset in which the first person utilizes a second personal asset from the pooled assets 708 at a second proximity location 502. In the instance of the first personal asset not being approximately identical to the second personal asset, the billing system of the asset queuing system 602 establishes a personal asset relative value ratio between the first personal asset and the second personal asset preferably with a personal asset relative time ratio between the first personal asset and the second personal asset.

Another embodiment of the asset queuing system 602 is a logistics transport (preferably an autonomous vehicle 496, though not shown in this figure) value ratio between a first forward logistics task and a second forward logistics task for instances in which the first forward logistics task is not approximately equivalent to a second forward logistics task; a first forward logistics task and a first reverse logistics task. Yet another embodiment of the asset queuing system 602 is a software access value ratio between a first software access task and a second software access task for instances in which the first software access task is not approximately equivalent in value to a second software access task. Another embodiment of the asset queuing system 602 is an aggregate personal contribution task value 806 and an aggregate personal utilization task value 804 in which computational tasks and/or primary asset task 612 are a function of the differential of aggregate personal contribution task value 806 and aggregate personal contribution task values 806 calculated on an at least one time interval selected from the group of individual day, individual week, individual month, individual quarter (i.e., 3 months), individual year, rolling (retroactive past seven days) week, rolling (retroactive past 30 days) month, rolling (retroactive past ninety days) quarter, or rolling (retroactive past 365 days) year. Yet another embodiment the differential of aggregate personal contribution task value 806 and aggregate personal utilization task values 804 times utilization adjustment ratio 808 (i.e., typically the utilization values are overweighted relative to the consumption values such that the utilization value: consumption value adjustment ratio is from 1:1 to 1:10 though preferably from 1:1 to 1:2). The preferred embodiment utilizes has the asset queuing system 602 as a function of at least the aggregate personal contribution task value 806 and aggregate personal utilization task values 804 times utilization adjustment ratio 808 to schedule the location of power generation system 458 assets and/or data center asset system 4-110 amongst a first proximity location 502 or a second proximity location 502 and at least one of proximity locations 502. The specifically preferred embodiment utilizes the asset queuing system 602 as a function of at least the aggregate personal contribution task value 806 and aggregate personal utilization task values 804 times utilization adjustment ratio 808 to additionally schedule the performance of primary asset tasks 612 and/or secondary asset tasks 802 amongst a first proximity location 502 or a second proximity location 502 and at least one of proximity locations 502.

Specific preference are characterized by a plurality of parameters 452 utilized to calculate the aggregate personal contribution task value 806 and aggregate personal utilization task values 804 times utilization adjustment ratio 808 where the personal contribution task value 806 is the summation of aggregate made available personal contribution task value 806 plus aggregate consumed of personal contribution task value 806 (i.e., the act of making an asset available for the asset queuing system 602 to schedule amongst a pool of assets from the total made available assets has value to the system even if an actual task is not performed ranging from at all, a fixed schedule, continuously, or discontinuously of the total made available asset time). Yet another embodiment has the differential of aggregate personal contribution task value 806 times consumption adjustment ratio 810 and aggregate personal utilization task values 804 times utilization adjustment ratio 808 (i.e., typically the consumption values for actual periods in which a task is performed of the total made available time are overweighted relative to standby periods in which no tasks are performed of the total made available time such that the consumption value with actual periods of total made available time: consumption value with standby periods of total made available time consumption value as a f(consumption adjustment ratio) is from 1:1 to 1:10 though preferably from 1:1 to 1:4). The consumption adjustment ratio 810 further differentiates between standby periods in which the asset queuing system 602 has explicitly requested an asset to become made available as solicited made available 812 for queuing with asset confirming availability for pool utilization versus the asset becoming “made available” on an unsolicited basis as unsolicited made available 814, such that a specifically preferred embodiment recognizes that a solicited made available 812 asset is substantially more valuable than an unsolicited made available 814 asset. An adjustment solicitation utilization adjustment ratio 808 adjusts value to the asset queuing system 602 between solicited made available: unsolicited made available 814 values from 1:1 to 1:20 though preferably from 1:4 to 1:15.

As noted previously the asset queuing system 602 has a dynamic addressing 604 and dynamic pricing system 702 that includes each proximity location 502 having at least one host community 504 always preferably having personal utilization task value 804 and personal contribution task value 806, Each pooled asset 708 preferably has solicited made available 812, unsolicited made available 814, consumption adjustment ratio 810, perishable capacity 710, and utilization adjustment ratio 808. Specifically preferred each pooled asset 708 has at least one of primary asset tasks 612 and secondary asset tasks 802. Each pooled asset 708 may optionally produce operational byproducts 704. Each proximity location 502 can have multiple host communities 504, though typically each host community 504 will in fact correspond to a distinct proximity location 502.

The dynamic pricing system 702 aggregates the operating costs comprised of a first operating cost at the first proximity location and an at least one second operating cost at the second proximity location by aggregate for each location an aggregate location revenue that is the sum of a revenue stream for the first proximity location and for each of the at least one second proximity locations. The dynamic pricing system also has an aggregate network revenue that is the sum for each location the aggregate location revenue for the first proximity location and for each of the at least one second proximity locations. This embodiment results in the aggregate network revenue being at least two percent higher (preferably at least five percent, and specifically preferred at least ten percent) with the dynamic pricing system when including a value for each of the operational byproducts for the first proximity location and for each of the at least one second proximity locations as compared to the absence of accounting for the value of each of the operational byproduct for the first proximity location and for each of the at least one second proximity locations.

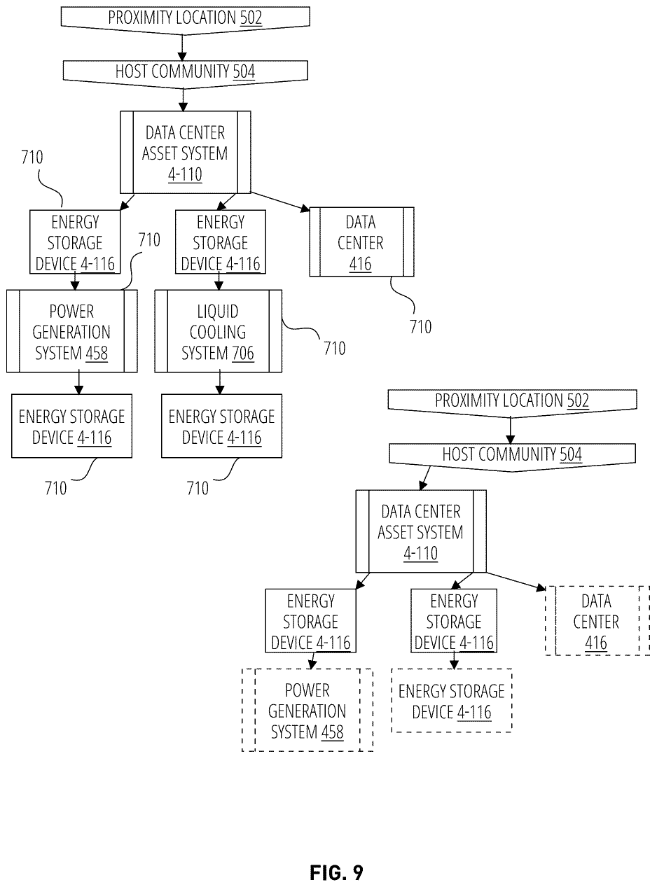

Turning to FIG. 9, FIG. 9 depicts a specifically optimized deployment of assets consisting of fixed location as well as deployable pooled assets 708 with the latter capable of moving from a first proximity location 502 (top left) to a second proximity location 502 (bottom right). Deployable pooled assets 708 are also referred to as decoupled assets such that at least one of the traditional data center asset system 4-110 components particularly with self-powered microgrid serving the host community 504 within the first proximity location 502 comprised of an at least one power generation system 458, and an at least one liquid cooling system 706 (or air-cooled air-cooling system 402 though not shown). The specifically optimized deployment leverages both a fixed firm energy storage device 4-116 (top left above the power generation system 458) and a deployable energy storage device 4-116 (top left below the power generation system 458 where the particularly preferred fixed firm energy storage device 4-116 and a deployable energy storage device 4-116 have a capacity ratio of at least 1:2 or 1:3 or 1;5 or 1:10 or greater than 1:10. The smaller fixed firm energy storage device 4-116 remains at the data center 416 to increase the buffer time (particularly to extend the time for logistics, or reduce the frequency of logistics movements. Decoupling the noted assets has the further advantage of increasing the utilization factor across the entire network within the asset queuing system 602. Though not shown for each asset, it is understood that each can have a perishable capacity 710 indicative to the asset queueing system for dynamic addressing 604 to achieve a higher utilization factor and a higher system revenue (or benefit value) preferably leveraging the feedforward control system 104 components (not shown on this figure). The dashed components as shown represent that any deployable asset is capable of being moved from the first proximity location 502 to any of the second proximity locations 502.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A deployable distributed data center asset system comprised of an at least two behind-the-meter power consuming locations; an at least one power generation system energy producing module produces a first same location waste heat wherein the at least one power generation system energy producing module is within the at least two behind-the-meter power consuming locations; the at least one power generation system energy producing module produces an excess same location electrical energy that is stored within an electrical energy storage device; an at least one data center asset system energy consuming module produces a second same location waste heat wherein the at least one data center asset system energy consuming module is within at least one of the at least two behind-the-meter power consuming locations; an at least one non-data center asset system energy consuming module wherein the at least one non-data center asset system energy consuming module is within the at least two behind-the-meter power consuming locations; wherein at least one of the first same location waste heat or the second same location waste heat is consumed at either of the at least two behind-the-meter power consuming locations; whereby each of the at least two behind-the-meter power consuming locations has an aggregate location power consuming operating cost that sums an aggregate location behind-the-meter power consuming operating cost and an optional aggregate location grid utility providers meter power consuming operating cost; whereby each of the at least two behind-the-meter power consuming locations has an aggregate alternative location power consuming operating cost that sums an aggregate location behind-the-meter power consuming operating cost and an optional aggregate location grid utility providers power consuming operating cost calculated without any consumption of the same location waste heat being consumed at either of the at least two behind-the-meter power consuming locations; whereby an aggregate network power consuming operating cost sums each of the aggregate location power consuming operating cost for each of the at least two behind-the-meter power consuming locations; whereby an aggregate alternative network power consuming operating cost sums each of the aggregate alternative location power consuming operating cost for each of the at least two behind-the-meter power consuming locations; and whereby the aggregate network power consuming operating cost is at least two percent lower than the aggregate alternative network power consuming operating cost.

2. The deployable distributed data center system according to claim 1 whereby the aggregate location power consuming operating cost is at least two percent lower than the aggregate alternative location power consuming operating cost for at least one of the at least two behind-the-meter power consuming locations.

3. The deployable distributed data center system according to claim 1 wherein the at least two behind-the-meter power consuming locations are comprised of at least a first behind-the-meter power consuming location and a second behind-the-meter power consuming location; and whereby the electrical energy storage device containing the excess same location electrical energy produced at the first behind-the-meter power consuming location is consumed at the second behind-the-meter power consuming location.

4. The deployable distributed data center system according to claim 1 wherein the at least two behind-the-meter power consuming locations are comprised of at least a first behind-the-meter power consuming location and a second behind-the-meter power consuming location; wherein at least one of the first same location waste heat or the second same location waste heat is an excess same location thermal energy that is stored within a thermal energy storage device; and whereby the thermal energy storage device containing the excess same location thermal energy produced at the first behind-the-meter power consuming location is consumed at the second behind-the-meter power consuming location.

5. The deployable distributed data center system according to claim 1 wherein the at least one power generation system energy producing module further comprises an input fuel source to produce an output electricity wherein the at least one power generation system energy producing module operates at approximately a peak efficiency operating condition whereby the output electricity ratio to the input fuel source is within five percent of the at least one power generation system energy producing module maximum peak efficiency operating condition.

6. The deployable distributed data center system according to claim 1 wherein the at least one power generation system energy producing module has a peak energy producing module capacity and an input fuel source to produce an output electricity wherein the input fuel source has a input fuel consumption rate that is always at least two percent greater than a peak fuel consumption rate required to product the output electricity at the peak energy producing module capacity.

7. The deployable distributed data center system according to claim 1 whereby each of the at least two behind-the-meter power consuming locations has an aggregate location power consuming carbon dioxide emissions that sums an aggregate location behind-the-meter power consuming carbon dioxide emissions and an optional aggregate location grid utility providers power consuming carbon dioxide emissions; whereby each of the at least two behind-the-meter power consuming locations has an aggregate alternative location power consuming carbon dioxide emissions that sums an aggregate location behind-the-meter power consuming carbon dioxide emissions and an optional aggregate location grid utility providers power consuming carbon dioxide emissions calculated without any consumption of the same location waste heat being consumed at either of the at least two behind-the-meter power consuming locations; whereby an aggregate network power consuming carbon dioxide emissions sums each of the aggregate location power consuming carbon dioxide emissions for each of the at least two behind-the-meter power consuming locations; whereby an aggregate alternative network power consuming carbon dioxide emissions sums each of the aggregate alternative location power consuming carbon dioxide emissions for each of the at least two behind-the-meter power consuming locations; and whereby the aggregate network power consuming carbon dioxide emissions is at least two percent lower than the aggregate alternative network power consuming carbon dioxide emissions.

8. The deployable distributed data center system according to claim 1 is further comprised of an location asset placement control system to reposition the data center asset system from a first proximity location to a second proximity location using a feedforward control system and feedback loop control system to coordinate the execution of an at least one primary asset task and an at least one secondary asset task.

9. The deployable distributed data center system according to claim 8 whereby the feedforward control feedforward calculates a feedforward variable based on the execution of the at least one primary asset task and the at least one secondary asset task for the first proximity location and at least one of the second proximity locations; obtaining a feedback variable to control a variable based on the primary asset task for the first proximity location and at least one of the second proximity locations; wherein determining a control variable based on a multivariable coupled combination of the feedforward variable and the feedback variable as calculated by a discretized dynamic equation with control of each performance of the primary asset tasks at each of the first proximity location and at least one of the second proximity locations creating a schedule to perform the at least one secondary asset tasks for each of the first proximity location and at least one of the second proximity locations; and wherein the discretized dynamic equation is comprising a feedforward response, a feedback response, a schedule for primary asset tasks, a schedule for secondary asset tasks as a function of time.

10. The deployable distributed data center system according to claim 9 wherein the discretized dynamic equation is based at least in part on a dynamic pricing system as a function of time for the scheduled primary asset tasks.

11. The deployable distributed data center system according to claim 9 wherein the discretized dynamic equation is based at least in part on a dynamic pricing system as a function of time for the scheduled secondary asset tasks.

12. The deployable distributed data center system according to claim 9 wherein the discretized dynamic equation is based at least in part on a dynamic pricing system as a function of time for both the scheduled primary asset tasks and the scheduled secondary asset tasks.

13. A deployable distributed data center asset system producing an operational byproduct, a first proximity location having a first data center performing an at least one primary asset task specific to the first data center and an at least one second proximity location having a second data center performing an at least one primary asset task specific to second data center, an aggregate operating cost comprised of a first operating cost at the first proximity location and an at least one second operating cost at the second proximity location; whereby an aggregate location revenue sums a revenue stream for the first proximity location and for each of the at least one second proximity locations as calculated by a dynamic pricing system; whereby an aggregate network revenue sums the aggregate location revenue for the first proximity location and for each of the at least one second proximity locations and whereby the aggregate network revenue is at least two percent higher with the dynamic pricing system including a value of each of the operational byproduct for the first proximity location and for each of the at least one second proximity locations as compared to the absence of accounting for the value of each of the operational byproduct for the first proximity location and for each of the at least one second proximity locations.

14. The deployable distributed data center system according to claim 13 is further comprised of a feedforward control system and feedback loop control system to coordinate the execution of an at least one primary asset task and an at least one secondary asset task; whereby the feedforward control feedforward calculates a feedforward variable based on the execution of the at least one primary asset task and the at least one secondary asset task for the first proximity location and at least one of the second proximity locations; obtaining a feedback variable to control a variable based on the primary asset task for the first proximity location and at least one of the second proximity locations; wherein determining a control variable based on a multivariable coupled combination of the feedforward variable and the feedback variable as calculated by a discretized dynamic equation with control of each performance of the primary asset tasks at each of the first proximity location and at least one of the second proximity locations creating a schedule to perform the at least one secondary asset tasks for each of the first proximity location and at least one of the second proximity locations; and wherein the discretized dynamic equation is comprising a feedforward response, a feedback response, a schedule for primary asset tasks, a schedule for secondary asset tasks as a function of time.

15. The deployable distributed data center system according to claim 14 wherein the discretized dynamic equation is based at least in part on a dynamic pricing system as a function of time for the scheduled primary asset tasks.

16. The deployable distributed data center system according to claim 14 wherein the discretized dynamic equation is based at least in part on a dynamic pricing system as a function of time for both the scheduled primary asset tasks and the scheduled secondary asset tasks.

17. A deployable distributed data center asset system comprised of a first proximity location having a first data center performing an at least one primary asset task specific to the first data center and an at least one second proximity location having a second data center performing an at least one primary asset task specific to second data center, an aggregate operating cost comprised of a first operating cost at the first proximity location and an at least one second operating cost at the second proximity location; whereby an aggregate location revenue sums a revenue stream for the first proximity location and for each of the at least one second proximity locations and reduces the aggregrate location revenue by a primary depreciation function and secondary depreciation function as calculated by a dynamic pricing system; whereby an aggregate network revenue sums the aggregate location revenue for the first proximity location and for each of the at least one second proximity locations and whereby the aggregate network revenue is at least two percent higher with the dynamic pricing system accounting for an amortization value of each of the first proximity location and for each of the at least one second proximity locations as compared to the absence of accounting for the amortization value of each of the primary depreciation functions and secondary depreciation functions for the first proximity location and for each of the at least one second proximity locations.

18. The deployable distributed data center system according to claim 17 is further comprised of a feedforward control system and feedback loop control system to coordinate the execution of an at least one primary asset task and an at least one secondary asset task; whereby the feedforward control feedforward calculates a feedforward variable based on the execution of the at least one primary asset task and the at least one secondary asset task for the first proximity location and at least one of the second proximity locations; obtaining a feedback variable to control a variable based on the primary asset task for the first proximity location and at least one of the second proximity locations; wherein determining a control variable based on a multivariable coupled combination of the feedforward variable and the feedback variable as calculated by a discretized dynamic equation with control of each performance of the primary asset tasks at each of the first proximity location and at least one of the second proximity locations creating a schedule to perform the at least one secondary asset tasks for each of the first proximity location and at least one of the second proximity locations; and wherein the discretized dynamic equation is comprising a feedforward response, a feedback response, a schedule for primary asset tasks, a schedule for secondary asset tasks as a function of time.

19. The deployable distributed data center system according to claim 18 wherein the discretized dynamic equation is based at least in part on a dynamic pricing system as a function of time for the scheduled primary asset tasks.

20. The deployable distributed data center system according to claim 18 wherein the discretized dynamic equation is based at least in part on a dynamic pricing system as a function of time for both the scheduled primary asset tasks and the scheduled secondary asset tasks.
